(19) United States
(12) Patent Application Publication
(10) Pub. No.: US 2013/0012370 A1
(43) Pub. Date: Jan. 10, 2013

(54) SHEET PROCESSING APPARATUS AND SHEET FOLDING METHOD

(75) Inventors: Tatsuhisa NARAOKA, Shizuoka-ken (JP); Naofumi Soga, Shizuoka-ken (JP); Jun Ishii, Shizuoka-ken (JP); Shoichi Dobashi, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/434,513

(22) Filed: Mar. 29, 2012

Related U.S. Application Data
(60) Provisional application No. 61/505,063, filed on Jul. 6, 2011.
(60) Provisional application No. 61/505,049, filed on Jul. 6, 2011.
(60) Provisional application No. 61/528,699, filed on Aug. 29, 2011.
(60) Provisional application No. 61/528,701, filed on Aug. 29, 2011.
(60) Provisional application No. 61/528,703, filed on Aug. 29, 2011.

(30) Foreign Application Priority Data
Mar. 26, 2012 (JP) P2012-68826
Mar. 26, 2012 (JP) P2012-68827
Mar. 27, 2012 (JP) P2012-70716

(51) Int. Cl. B31B 1/56

(52) U.S. Cl. 493/454

(57) ABSTRACT

According to one embodiment, a sheet processing apparatus includes a folding unit, a fold reinforcing roller, a driving circuit, and a controller. The folding unit folds a sheet bundle to form a fold. The fold reinforcing roller nips the fold of the sheet bundle having the fold formed thereon and conveyed to a fold reinforcing position, reciprocatingly moves along the direction of the fold, and reinforces the fold of the sheet bundle. The driving circuit drives the fold reinforcing roller along the direction of the fold. The controller controls the number of times of the reciprocating movement of the fold reinforcing roller on the basis of a value of an electric current of the driving circuit flowing when the fold reinforcing roller that starts driving from a standby position rides over an end of the sheet bundle.

### CROSS-REFERENCE TO RELATED APPLICATIONS

This application is based upon and claims the benefit of priority from the prior the U.S. Patent Application No. 61/505,053, filed on Jul. 6, 2011, and the prior the U.S. Patent Application No. 61/505,049, filed on Jul. 6, 2011, and the prior the U.S. Patent Application No. 61/528,699, filed on Aug. 29, 2011, and the prior the U.S. Patent Application No. 61/528,701, filed on Aug. 29, 2011, and the prior the U.S. Patent Application No. 61/528,703, filed on Aug. 29, 2011, and Japanese Patent Application No. 2012-68826, filed on Mar. 26, 2012, and Japanese Patent Application No. 2012-68827, filed on Mar. 26, 2012, and Japanese Patent Application No. 2012-70716, filed on Mar. 27, 2012, and the entire contents all of which are incorporated herein by reference.

### FIELD

Embodiments described herein relate generally to a sheet processing apparatus and a sheet folding method for reinforcing a fold of a folded sheet.

### BACKGROUND

There is a sheet finishing apparatus that is set on a downstream side in a sheet conveying direction of an image forming apparatus such as a copying machine, a printer, or a multi-functional peripheral (MFP) and applies finishing such as punching or stapling to printed sheets. The sheet finishing apparatus includes a function of folding for folding a part of sheets and a function of saddle stapling and saddle folding for folding sheets in the center after stapling the center of the sheets with staples in addition to functions of punching and stapling. The function of saddle stapling and saddle folding can produce (bind) a booklet from printed plural sheets.

In the saddle stapling and saddle folding, the sheet finishing apparatus forms a fold and folds a stapling portion of sheets with a pair of rollers called a folding roller pair after stapling the center of sheets with staples. For example, the sheet finishing apparatus striking a tabular member called a folding blade against a stapling portion of a sheet bundle and pushes the sheet bundle into a nip portion of the folding roller pair to fold the sheet bundle.

However, time when a folded portion of the sheet bundle is pressed by the nip portion of the folding roller pair is short. The pressure is dispersed to the entire fold because the entire folded portion is simultaneously pressed by the nip portion of the folding roller pair. Therefore, the fold formed by the folding roller pair is not sufficiently pressed. In particular, when the number of sheets is large or when a thick sheet is included in the sheet bundle, an incomplete fold is formed.

To cope with this problem, there is a technique for providing a fold reinforcing unit including a fold reinforcing roller and reinforcing the fold formed by the folding roller pair using the fold reinforcing roller. The fold reinforcing roller is, for example, a pair of rollers movable along the fold of the sheet bundle. The fold reinforcing unit nips the fold of the sheet bundle in a nip portion of the fold reinforcing roller and moves the fold reinforcing roller along the fold while applying pressure to the nip portion to thereby reinforce the fold of the sheet bundle. The fold reinforcing roller of the fold reinforcing unit usually stays on standby in a home position slightly separated from an end of the sheet bundle. In the fold reinforcing processing, the fold reinforcing roller moves from the home position, reciprocatingly moves along the fold of the sheet bundle, and returns to the home position when the fold reinforcing processing ends.

The apparatus in the past determines the number of times of fold reinforcement according to a sheet size and a type of a sheet. Therefore, actually, even in a state in which fold reinforcement is in sufficient, the apparatus completes the fold reinforcing processing and discharges the sheet bundle. Further, even in a state in which the fold formed by the folding roller pair is insufficient, the apparatus in the past performs the fold reinforcing processing.

Therefore, there is a demand for a sheet processing apparatus that more appropriately performs the fold reinforcing processing than the sheet processing apparatus including the fold reinforcing unit in the past.

### DESCRIPTION OF THE DRAWINGS

FIG. 1 is a block diagram for explaining a hardware configuration of an image forming apparatus and a sheet processing apparatus in a first embodiment;

FIG. 2 is a schematic diagram for explaining the configuration of the sheet processing apparatus;

FIG. 3 is a schematic perspective view for explaining the overall structure of a fold reinforcing unit in the first embodiment;

FIGS. 4A and 4B are schematic sectional views for explaining a supporting section in the first embodiment;

FIG. 5 is a perspective external view of a structure example of a roller unit in the first embodiment;

FIG. 6 is a schematic diagram for explaining a driving section in the first embodiment;

FIG. 7 is a schematic diagram for explaining a mechanism of up and down driving of an upper roller in the first embodiment;

FIG. 8 is a block diagram for explaining driving control of the roller unit;

FIG. 9 is a flowchart for explaining fold reinforcing processing by the sheet processing apparatus;

FIG. 10 is a diagram for explaining the fold reinforcing processing;

FIG. 11 is a schematic diagram for explaining a detection sensor in a second embodiment;

FIG. 12 is a schematic diagram for explaining the detection sensor;

FIG. 13 is a flowchart for explaining fold reinforcing processing by a sheet processing apparatus in the second embodiment;

FIG. 14 is a flowchart for explaining fold reinforcing processing by a sheet processing apparatus in a modification of the second embodiment;

FIGS. 15A to 15C are schematic diagrams for explaining a roller unit in a third embodiment;

FIG. 16 is a flowchart for explaining control of a sheet processing apparatus in the third embodiment;

FIGS. 17A and 17B are schematic diagrams for explaining a modification of the roller unit;

FIG. 18 is a schematic perspective view for explaining the overall configuration of a folding unit in a fourth embodiment;

FIG. 19 is a schematic diagram for explaining a detection unit in the fourth embodiment;

FIG. 20 is a flowchart for explaining fold reinforcing processing by a sheet processing apparatus in the fourth embodiment;

FIG. 21 is a diagram for explaining the fold reinforcing processing;

FIG. 22 is a schematic diagram for explaining a detection unit in a fifth embodiment; and

FIG. 23 is a flowchart for explaining fold reinforcing processing by a sheet processing apparatus in the fifth embodiment.

### DETAILED DESCRIPTION

Exemplary embodiments are explained below with reference to the accompanying drawings.

### First Embodiment

According to a first embodiment, a sheet processing apparatus includes a folding unit, a fold reinforcing roller, a driving circuit, and a controller. The folding unit folds a sheet bundle including plural sheets to form a fold. The fold reinforcing roller nips the fold of the sheet bundle having the fold formed thereon and conveyed to a fold reinforcing position, reciprocatingly moves along the direction of the fold, and reinforces the fold of the sheet bundle. The driving circuit drives the fold reinforcing roller along the direction of the fold. The controller controls the number of times of the reciprocating movement of the fold reinforcing roller on the basis of a value of an electric current of the driving circuit flowing when the fold reinforcing roller that starts driving from a standby position rides over an end of the sheet bundle.

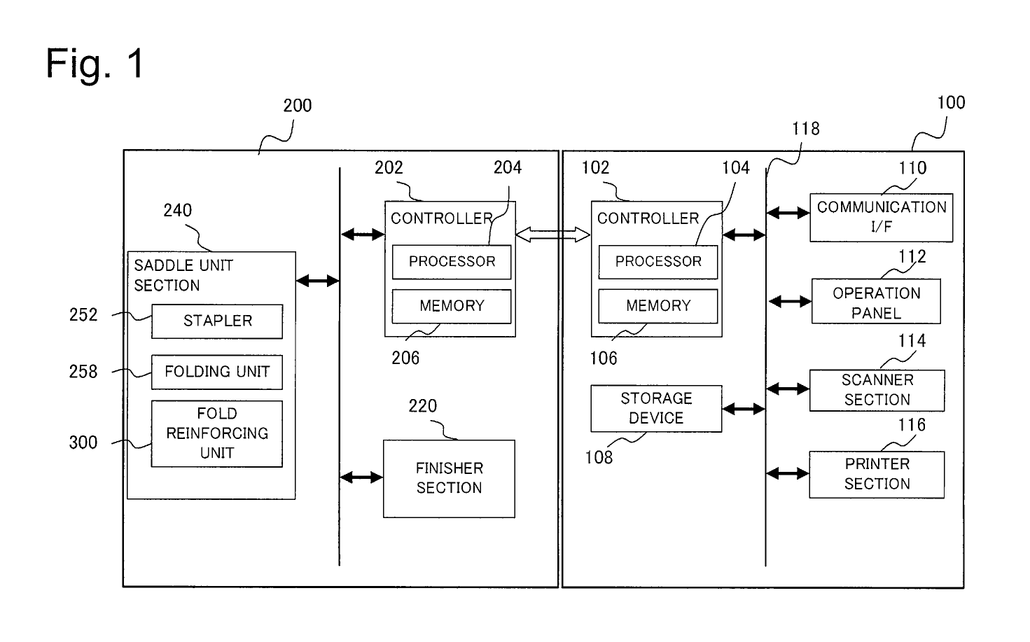

FIG. 1 is a block diagram for explaining a hardware configuration of an image forming apparatus and a sheet processing apparatus. An image forming apparatus 100 includes a controller 102, a storage device 108, a communication interface (communication I/F) 110, an operation panel 112, a scanner section 114 that reads an original document, and a printer section (an image forming section) 116 that forms an image. The components of the image forming apparatus 100 are connected via a bus 118.

The controller 102 includes a processor 104 including a CPU (Central Processing Unit) or an MPU (Micro Processing Unit) and a memory 106. The memory 106 is, for example, a semiconductor memory and includes a ROM (Read Only Memory) having stored therein a control program and the like and a RAM (Random Access Memory) that provides the processor 104 with a temporary work area. The controller 102 controls the operation panel 112, the scanner section 114, and the printer section 116 on the basis of various computer programs and the like stored in the ROM and the storage device 108. The controller 102 has a function of correcting or decompressing image data. The controller 102 communicates with a controller 202 of a sheet processing apparatus 200.

The storage device 108 stores application programs and an OS. The application programs include programs for executing functions of a multifunction peripheral such as a copy function, a print function, a scanner function, a facsimile function, and a network file function. The application programs further include an application for a Web client (a Web browser) and other applications.

The storage device 108 temporarily stores, for example, image data of an original document read by the scanner section 114 or image data acquired via the communication I/F 110. Further, the storage device 108 appropriately stores software update, a protected electronic document, text data, account information, policy information, and the like. The storage device 108 may be, for example, a magnetic storage device such as a hard disk drive, an optical storage device, a semiconductor storage device (a flash memory, etc.), or an arbitrary combination of these storage devices.

The communication I/F 110 is an interface connected to an external apparatus. The communication I/F 110 is connected to the external apparatus via appropriate wireless or wired connection conforming to IEEE802.15, IEEE802.11, IEEE802.3, IEEE1284, or the like such as Bluetooth (registered trademark), infrared connection, or optical connection. The communication I/F 110 may further include a USB connection section, a parallel interface, or the like to which a connection terminal of the USB standard is connected. The controller 102 communicates with a user terminal, a USB device, and other external apparatuses via the communication I/F 110.

The operation panel 112 includes a display section of a touch panel type and various operation keys. The operation keys include, for example, a ten key, a reset key, a stop key, and a start key. The display section displays instruction items concerning printing conditions such as a sheet size, the number of copies, printing density setting, or finishing (stapling or folding). Instructions of the displayed items are input from the display section.

The scanner section 114 includes an incorporated scanning and reading unit that reads an original document as an image, a document placing table, and an automatic document feeder that conveys the original document to a reading position. The scanning and reading unit of the scanner section 114 reads an original document set on the document placing table or the automatic document feeder.

The printer section 116 includes an image forming unit including, for example, a photoconductive drum and a developing unit for development with, for example, a toner, which are publicly known. The printer section 116 forms, with these units, an image corresponding to image data of the original document read by the scanner section 114 or an image corresponding to image data sent from a user terminal on a sheet.

The sheet processing apparatus 200 includes the controller 202, a finisher section 220, and a saddle unit section 240. The controller 202 (a controller) includes a processor 204 including a CPU (Central Processing Unit) or an MPU (Micro Processing Unit) and a memory 206. The memory 206 is, for example, a semiconductor memory and includes a ROM (Read Only Memory) having stored therein a control program and the like and a RAM (Random Access Memory) that provides the processor 204 with a temporary work area. The controller 202 communicates with the controller 102 of the image forming apparatus 100. The controller 202 controls the finisher section 220 and the saddle unit section 240 on the basis of information received from the controller 102 and various computer programs and the like stored in the ROM and the like. The saddle unit section 240 in this embodiment includes a stapler 252, a folding unit 258, and a fold reinforcing unit 300.

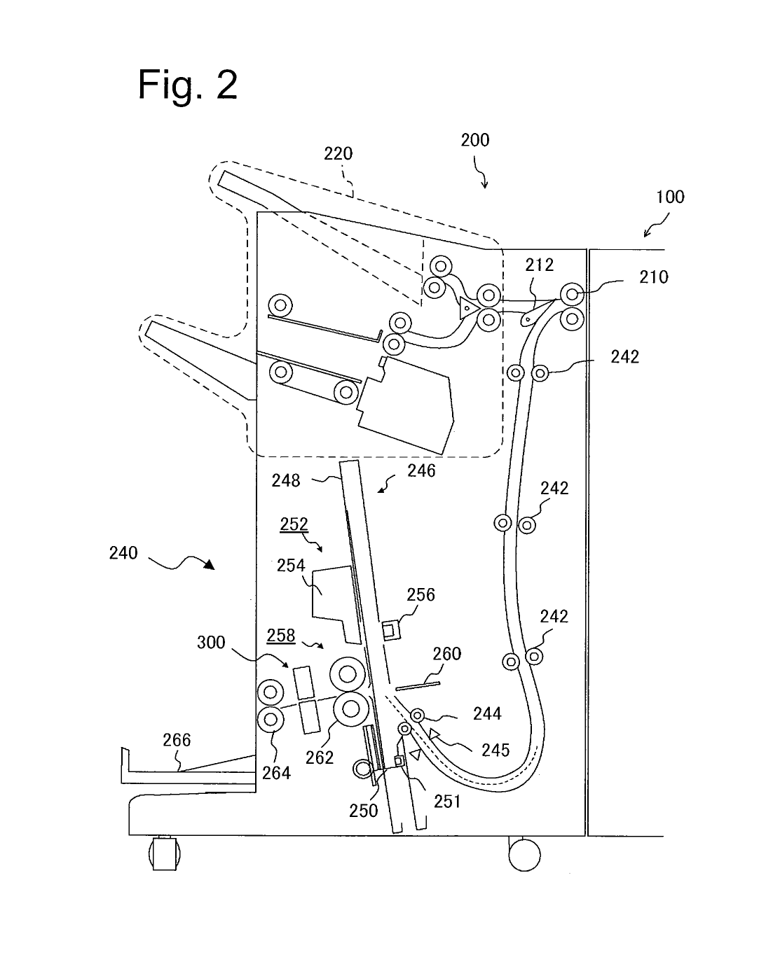

FIG. 2 is a schematic diagram for explaining the configuration of the sheet processing apparatus.

The sheet processing apparatus 200 processes, according to an input instruction from the operation panel 112 or an instruction from a user terminal, sheets discharged from the image forming apparatus 100. The sheet processing apparatus 200 includes an inlet roller 210, a diverting member 212, the finisher section 220, and the saddle unit section 240. The inlet roller 210 carries a sheet, which is carried out from the image forming apparatus 100, into the sheet processing apparatus 200. The diverting member 212 switches a conveyance destination of the sheet carried in by the inlet roller 210 to the finisher section 220 or the saddle unit section 240 according to processing contents input via the display section of the operation panel 112 of the image forming apparatus 100 shown in FIG. 1. For example, the finisher section 220 sorts a sheet bundle or staples an end of the sheet bundle. The finisher section 220 may be, for example, a finishing apparatus disclosed in the specification and the drawings of JP-A-2007-76862.

The saddle unit section 240 staples or folds a sheet bundle. The saddle unit section 240 includes plural conveying rollers 242, a carry-out roller 244, a carry-out roller sensor 245, a stacking section 246, the stapler 252, the folding unit 258, the fold reinforcing unit 300, a discharge roller 264, and a sheet bundle stacking tray 266. The conveying rollers 242 convey a sheet to the stacking section 246. The carry-out roller 244 carries out the sheet to the stacking section 246. The carry-out roller sensor 245 detects the sheet being carried out.

The stacking section 246 includes a stack tray 248, a stacker 250, and a sensor 251. The stacking section 246 temporarily stacks a sheet in an upright position. The stack tray 248 supports the surface of the sheet. The stacker 250 receives the lower end of the sheet. The stacker 250 supports the lower end of the sheet stacked in the upright position and aligns (longitudinally aligns) the position of an end of the sheet in a conveying direction of the sheet. The sheet stacked on the stacking section 246 is aligned in the width direction, which crosses the sheet conveying direction, as well. The alignment in the width direction (lateral alignment) of the sheet is omitted. The sensor 251 detects that the sheet is conveyed to the stacker 250.

The stacker 250 moves up and down along the stack tray 248. The stacker 250 adjusts the position of sheets to be stapled by the stapler 252 and the position of sheets to be folded by the folding unit 258. In the following explanation of this embodiment, as an example, it is assumed that the position of the sheets to be stapled and the position of the sheets to be folded are the center in the sheet conveying direction.

Plural (e.g., two) staplers 252 are arranged side by side in the sheet width direction. The stapler 252 includes a stapler head 254 and an anvil 256. The stapler head 254 and the anvil 256 staple a sheet bundle.

When the stapler 252 staples the sheet bundle, the stacker 250 moves to set a stapled position of the sheets in a position of the sheets to be folded by the folding unit 258. When the stacker 250 stops, the folding unit 258 starts folding.

The folding unit 258 includes a folding plate 260 and a folding roller pair 262. The folding plate 260 stays on standby in a position where the folding plate 260 does not obstruct the conveyance of the sheets. When a position where a fold should be formed on the sheets moves to the front of the folding plate 260, the folding plate 260 moves toward the folding roller pair 262. The distal end of the folding plate 260 strikes the sheet bundle and pushes the sheet bundle to a nip portion of the rotating folding roller pair 262. The folding roller pair 262 nips and presses, conveys, and folds the sheet bundle pushed by the folding plate 260. The sheet bundle having a fold formed by the folding unit 258 is further conveyed to the fold reinforcing unit 300 provided on the downstream side of the folding unit 258.

The fold reinforcing unit 300 moves in the width direction (a direction along a line of the fold), which crosses a conveying direction of the sheet bundle, while pressing the fold and reinforces the fold formed by the folding unit 258 (fold reinforcing processing). The fold reinforcing unit 300 is explained below. The sheet bundle, the fold of which is reinforced by the fold reinforcing unit 300, is discharged to the sheet bundle stacking tray 266 by the discharge roller 264.

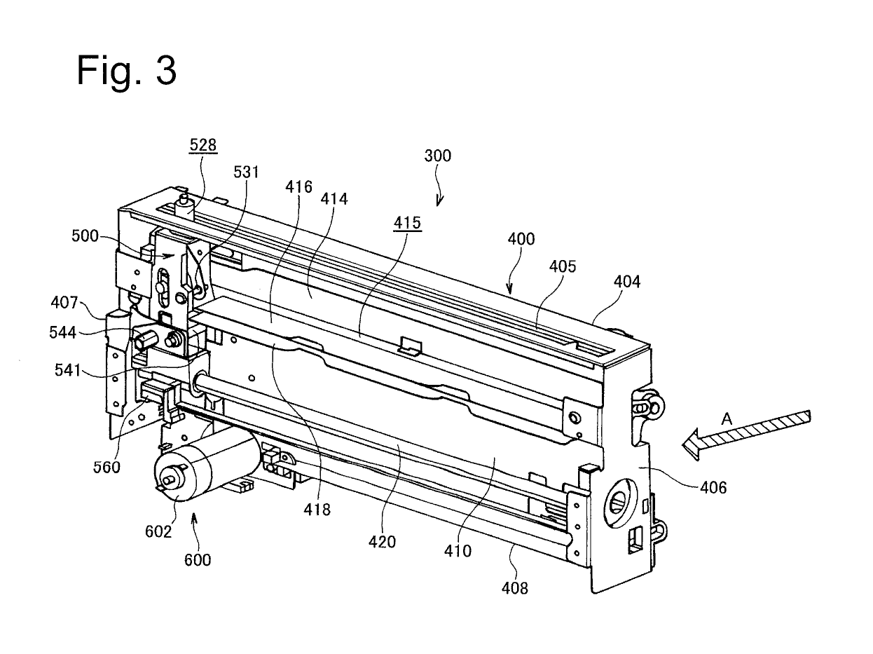

FIG. 3 is a schematic perspective view for explaining the overall structure of the fold reinforcing unit 300. The fold reinforcing unit 300 includes a supporting section 400, a fold reinforcing roller unit 500 (hereinafter simply referred to as roller unit 500), a driving section 600, and a detecting member 560. The supporting section 400 is a part of a structure member of the entire fold reinforcing unit 300. The supporting section 400 supports the roller unit 500 to be slidable in a fold direction (the width direction crossing the sheet bundle conveying direction). The roller unit 500 moves along the fold of the sheet bundle folded by the folding roller pair 262 provided upstream of the roller unit 500 and presses the fold of the sheet bundle to reinforce the fold of the sheet bundle. The driving section 600 includes a driving motor 602. The driving section 600 moves the roller unit 500 along the fold of the sheet bundle. The detecting member 560 detects whether the roller unit 500 is present in a home position. The detecting member 560 may be, for example, a micro sensor or a micro actuator.

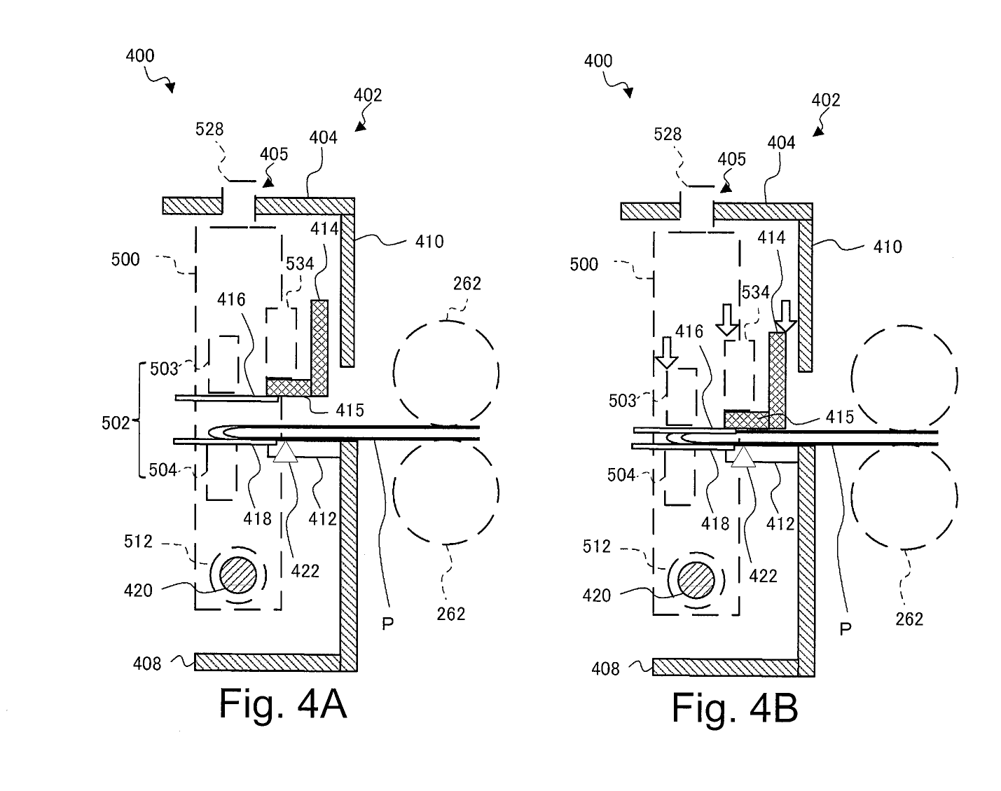

The supporting section 400 is explained with reference to FIG. 3 and FIGS. 4A and 4B. FIGS. 4A and 4B are schematic sectional views for explaining the supporting section 400. A state in which the roller unit 500 is present in the home position is shown in FIG. 4A. A state in which the roller unit 500 moves and reinforces the fold of the sheet bundle is shown in FIG. 4B. The supporting section 400 includes a frame 402, a conveyance guide 414, flexible members 416 and 418, and a supporting shaft 420.

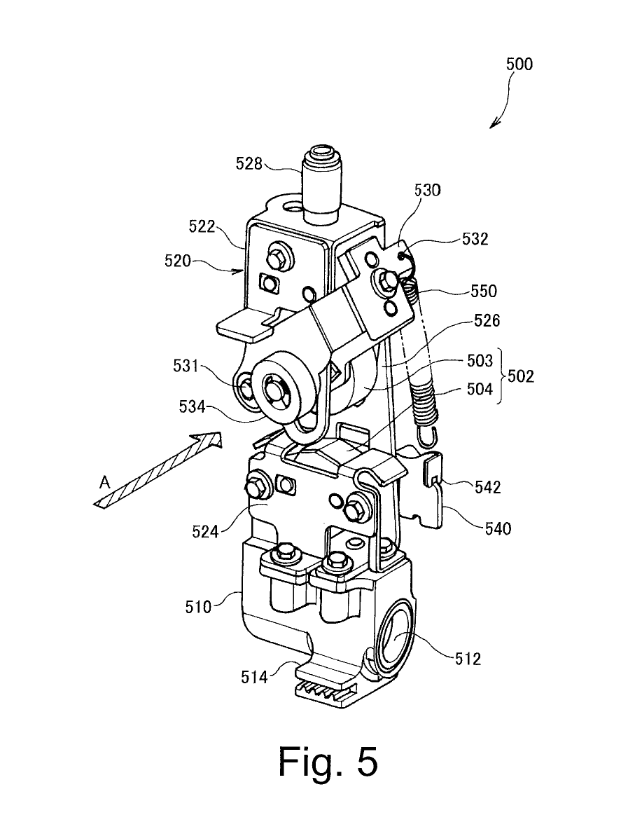

The frame 402 includes a top plate 404, left and right side plates 406 and 407, a bottom plate 408, an inner plate 410, and a sheet bundle placing table 412. The top plate 404 has a supporting hole 405 extending in a longitudinal direction of the supporting section 400. The supporting hole 405 slidably holds a supporting roller 528 for posture retaining provided in an upper part of the roller unit 500 shown in FIG. 5. The side plates 406 and 407 support the supporting shaft 420. The supporting shaft 420 slidably supports the roller unit 500. The supporting shaft 420 is inserted into a through hole 512 of the roller unit 500 explained below. The position of the roller unit 500 (excluding a position change in a moving direction) and the posture of the three axes are regulated by the supporting shaft 420 and the through hole 512 and the supporting hole 405 and the supporting roller 528. The position and the posture are retained constant even during the movement of the roller unit 500.

The conveyance guide 414 is arranged between the side plates 406 and 407. The conveyance guide 414 includes a bottom plate 415. The flexible member 416 is attached to the bottom plate 415. The flexible member 416 is a belt-like member formed of a film-like resin member of polyethylene terephthalate (PET) or the like. The flexible member 418 and the sheet bundle placing table 412 are provided below the flexible member 416. The flexible member 418 is attached to the sheet bundle placing table 412 to be opposed to the flexible member 416.

When a fold of a sheet bundle P is reinforced, the fold of the sheet bundle P is located in a fold reinforcing position (a position where the sheet bundle P is nipped by a fold reinforcing roller 502) between the flexible members 416 and 418, as shown in FIGS. 4A and 4B. Specifically, the fold reinforcing roller 502 (an upper roller 503 and a lower roller 504) explained below presses the fold of the sheet bundle P via the flexible members 416 and 418 and reinforces the fold. Occurrence of scratches and creases in the fold and near the fold is prevented by pressing the fold of the sheet bundle P via the flexible members 416 and 418.

Control for conveying a sheet bundle to the fold reinforcing position is explained. The supporting section 400 includes a sheet bundle detection sensor 422. In this embodiment, the sheet bundle detection sensor 422 is arranged in the sheet bundle placing table 412. The sheet bundle detection sensor 422 may be, for example, a micro sensor or a micro actuator. A folding roller motor (not shown) that rotates the folding roller pair 262 performs driving in the sheet bundle conveying direction. The controller 202 controls the conveyance of the sheet bundle by controlling rotating speed and the rotation amount of the folding roller motor. Specifically, the controller 202 controls the rotation of the folding roller motor on the basis of a signal output by the sheet bundle detection sensor 422 and indicating that a fold of the sheet bundle is detected and stops the sheet bundle in the fold reinforcing position. For example, when the controller 202 receives the signal indicating the sheet bundle detection from the sheet bundle detection sensor 422, after driving the folding roller motor a predetermined number of pulses, the controller 202 stops the folding roller motor to stop the sheet bundle in the fold reinforcing position.

The structure of the roller unit 500 is explained. FIG. 5 is a perspective external view of a structure example of the roller unit 500 and is a diagram of the roller unit 500 viewed from the sheet bundle conveying direction (an arrow A direction in FIG. 3).

The roller unit 500 incorporates the fold reinforcing roller 502. The roller unit 500 includes a unit supporting section 510 and a unit frame 520. The unit supporting section 510 includes the through hole 512 into which the supporting shaft 420 is inserted and a connecting section 514 connected to a unit driving belt of the driving section 600 explained below. The unit frame 520 is attached above the unit supporting section 510.

The unit frame 520 includes the fold reinforcing roller 502. The unit frame 520 includes an upper frame 522, a lower frame 524, a frame plate 526 that fixes the upper frame 522 and the lower frame 524, an upper link member 530, and a lower link member 540. The unit frame 520 includes the supporting roller 528 for retaining the posture of the roller unit 500.

The upper link member 530 is pivotably attached to the upper frame 522 via an upper link shaft 531. The lower link member 540 is pivotably attached to a side surface of the lower frame 524 via a lower link shaft 541 (see FIG. 3) fixed to the lower frame 524. The upper link member 530 and the lower link member 540 are coupled by a spring 550. One end of the spring 550 is locked to a hook hole 532 of the upper link member 530. The other end of the spring 550 is locked to a cutout section 542 of the lower link member 540. In FIG. 5, the spring 550 in a free state in which the other end of the spring 550 is unlocked from the cutout section 542 is shown. However, in a state in which the other end of the spring 550 is actually locked to the cutout section 542, a tensile force of the spring 550 is applied between the upper link member 530 and the lower link member 540.

The upper link member 530 rotatably pivotally supports the upper roller 503, which is one of the rollers of the fold reinforcing roller 502. An upper roller shaft of the upper roller 503 is fixed to the upper link member 530. The upper frame 522 has a hollow section. The upper roller 503 pivotally supported by the upper link member 530 is housed in the hollow section. When the roller unit 500 is located in the home position, the upper roller 503 is present in a position apart from the lower roller 504. When the roller unit 500 separates from the home position and starts movement, the upper link member 530 is pulled by the spring 550 and starts to rotate downward around the upper link shaft 531. Consequently, the upper roller 503 rotatably attached to the upper link member 530 falls. The upper roller 503 moves from a position apart from the lower roller 504 to a position in contact with the lower roller 504.

The upper link member 530 includes a conveyance guide roller 534 that presses the conveyance guide 414 downward during the fold reinforcing processing. When the roller unit 500 separates from the home position, the conveyance guide roller 534 falls in the same manner as the upper roller 503 and presses the bottom plate 415 of the conveyance guide 414 from above (see FIGS. 4A and 4B). The descent of the conveyance guide roller 534 is realized by a mechanism explained below same as the mechanism of the descent of the upper roller 503. The conveyance guide 414 presses the sheet bundle from above and prevents a lateral shift of the sheet bundle.

On the other hand, like the upper frame 522, the lower frame 524 has a hollow section. The lower roller 504, which is the other of the rollers of the fold reinforcing roller 502, is housed in the hollow section. The lower frame 524 rotatably pivotally supports the lower roller 504. A rotating shaft of the lower roller 504 is fixed to the lower frame 524 (i.e., fixed to the unit frame 520). Therefore, even when the roller unit 500 moves, the position in the height direction of the lower roller 504 (or the thickness direction of the sheet bundle) does not change. In this embodiment, the position of the upper end of the lower roller 504 is adjusted to a position substantially equal to the position of the flexible member 418. Therefore, when the roller unit 500 moves, the lower roller 504 rotates while coming into contact with the lower surface of the flexible member 418 (see FIG. 4B). In this way, during the fold reinforcing processing, the sheet bundle is held between the upper roller 503 and the lower roller 504 via the flexible members 416 and 418. The fold of the sheet bundle is reinforced by a pressing force between the upper roller 503 and the lower roller 504.

As shown in FIG. 3, the lower link member 540 includes a guide roller 544 that freely rotates. The guide roller 544 is a part of a configuration for moving the upper roller 503 up and down. A mechanism of the up and down movement of the upper roller 503 is explained below.

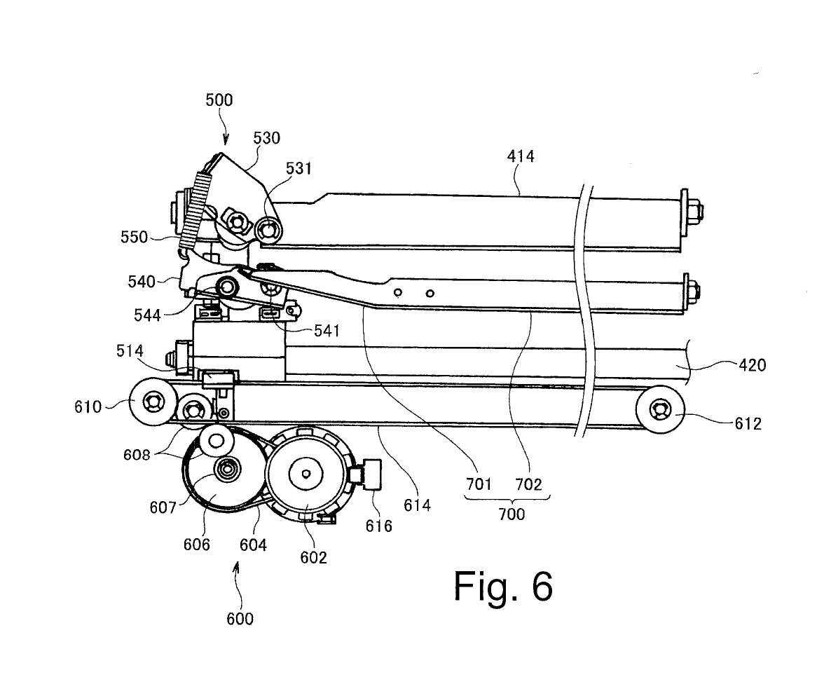

The structure of the driving section 600 is explained. FIG. 6 is a schematic diagram for explaining the configuration of the driving section 600. FIG. 6 is a diagram of the driving section 600 viewed from the arrow A direction in FIG. 3. The roller unit 500 present in the home position is also shown in the figure. A part of a structure member of the supporting section 400 is not shown for convenience of explanation. In this embodiment, the home position of the roller unit 500 is set in a position where the roller unit 500 does not interfere with a sheet bundle having a processable maximum size. On the other hand, a position most distant from the home position in a movable range in a fold direction of the roller unit 500 (the width direction crossing the sheet bundle conveying direction) is set in a range in which the nip portion of the fold reinforcing roller 502 does not move beyond an end of the sheet bundle having the processable maximum size.

The driving section 600 includes the driving motor 602 functioning as a driving source for the fold reinforcing unit 300. The driving motor 602 is, for example, a direct-current motor (DC motor). The controller 202 controls the rotating direction and the rotating speed of the driving motor 602. Driving force by the driving motor 602 is transmitted to a pulley 606 via a motor belt 604 and further transmitted from a gear 607 of the pulley 606 to a driving side pulley 610 via a gear 608. The driving side pulley 610 suspends and stretches a unit driving belt 614 in cooperation with a driven side pulley 612.

The unit driving belt 614 moves between the driving side pulley 610 and the driven side pulley 612 with the driving force by the driving motor 602. The unit driving belt 614 includes a rack on the surface thereof. The rack of the unit driving belt 614 fits with the connecting section 514 below the roller unit 500. The unit driving belt 614 moves the roller unit 500 in the fold direction. If the rotating direction of the driving motor 602 is reversed, the moving direction of the unit driving belt 614 is changed to the opposite direction. Consequently, the roller unit 500 reciprocatingly moves.

The controller 202 of the sheet processing apparatus 200 shown in FIG. 1 controls the rotation of the driving motor 602 to thereby control the movement amount and the moving speed of the unit driving belt 614, i.e., the movement amount and the moving speed of the roller unit 500. The rotation amount and the rotating speed of the driving motor 602 are detected according to a pulse signal sequence output from an encoder sensor 616 disposed in close contact with the driving motor 602. The controller 202 controls the rotation of the driving motor 602 on the basis of the detected rotation amount and the detected rotating speed. The driving motor 602 may be a pulse motor. In this case, the controller detects rotating speed by counting pulses directly output from the driving motor 602.

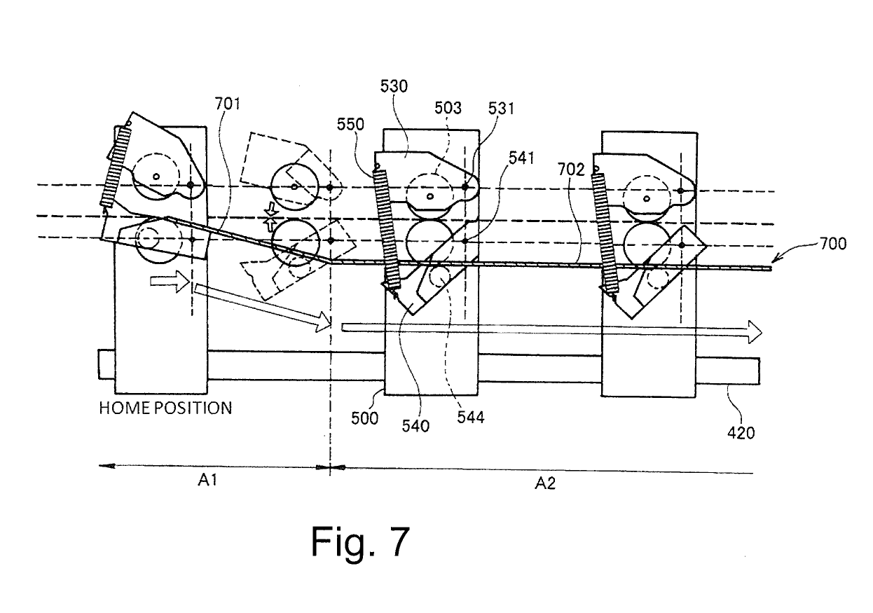

The mechanism of the up and down driving of the upper roller 503 is explained with reference to FIGS. 3, 6, and 7. FIG. 7 is a diagram for explaining the mechanism of the up and down driving of the upper roller 503. As explained above, the upper link member 530 and the lower link member 540 of the roller unit 500 are connected by the spring 550 in a position most distant from the rotating shafts (the upper link shaft 531 and the lower link shaft 541) of the link members. The lower link member 540 includes the guide roller 544 that freely rotates.

The supporting section 400 shown in FIGS. 3 and 4 includes a guide rail 700 formed in an L shape in cross section as shown in FIGS. 6 and 7. The guide rail 700 includes a first guide section 701 inclining near the home position and a second guide section 702 other than the first guide section 701. The second guide section 702 is arranged in parallel to the fold direction of the sheet bundle. In FIG. 7, an area where the first guide 701 is present is referred to as inclined area A1 and an area where the second guide section 702 is present is referred to as effective driving area A2. The height in the moving direction of the upper link shaft 531 and the lower link shaft 541 of the roller unit 500 that moves in the inclined area A1 and the effective driving area A2 is fixed.

As shown in FIG. 7, in the inclined area A1, the roller unit 500 starts the movement from the home position. When the roller unit 500 is driven by the driving belt 614 and separates from the home position, the guide roller 544 comes into contact with the bottom surface of the first guide section 701 of the guide rail 700. Thereafter, the guide roller 544 falls along the bottom surface of the first guide section 701. According to the descent of the guide roller 544, the lower link member 540 rotates about the lower link shaft 541 in the counterclockwise direction in FIG. 7. The upper link member 530 is pulled by the spring 550 and also rotates in the counterclockwise direction about the upper link shaft 531. As a result, the upper roller 503 present between the upper link shaft 531 and the hook hole 532 of the spring 550 gradually falls while the roller unit 500 moves on the first guide section 701. A space between the upper roller 503 and the lower roller 504 gradually decreases. The upper roller 503 and the lower roller 504 come into contact with each other near an area where the first guide section 701 ends. At this point, pressures (pressing forces) against each other act between the upper roller 503 and the lower roller 504. The pressing forces are based on the tensile force by the spring 550.

In the second guide section 702 (i.e., the effective driving area A2) of the guide rail 700, the upper roller 503 and the lower roller 504 apply pressure to the fold of the sheet bundle while maintaining the pressing forces. The roller unit 500 that reinforces the fold moves along the fold while reinforcing the fold and once stops at the end of the sheet bundle on the opposite side of the home position. Thereafter, the roller unit 500 moves on the backward path while continuing to reinforce the fold and returns to the home position. The position of the end on the opposite side of the home position (a turning position) where the roller unit 500 once stops and turns may be determined on the basis of information concerning a sheet size or may be fixed for all sheet sizes. In this embodiment, the position is determined on the basis of the information concerning the sheet size.

The controller 202 of the sheet processing apparatus 200 controls timing for starting the driving of the roller unit 500 present in the home position. When the sheet bundle is conveyed to the fold reinforcing unit 300, the controller 202 determines, on the basis of a signal from the sheet bundle detection sensor 422, whether the leading end of the folded sheet bundle is conveyed to the fold reinforcing position. When the leading end of the sheet bundle, i.e., the fold is conveyed to the fold reinforcing position, the controller 202 stops the conveyance of the sheet bundle. Subsequently, the controller 202 starts the movement (the forward path) from the home position of the roller unit 500. When the roller unit 500 moves from the home position, the detecting member 560 shown in FIG. 3 changes from ON to OFF.

The controller 202 moves the roller unit 500 in the fold direction by a predetermined amount from a position where the detecting member 560 is turned off. The controller 202 stops the roller unit 500 in the position at the end of the sheet bundle on the opposite side of the home position (the turning position). The controller 202 calculates the movement amount of the roller unit 500 on the basis of, for example, the number of pulses of an encoder of the driving motor 602. When the roller unit 500 stops in the turning position, the controller 202 counts a stop time. When the stop time exceeds a predetermined time, the controller 202 moves the roller unit 500 in the opposite direction (the backward path). The controller 202 stops the roller unit 500 in the home position on the basis of a signal from the detecting member 560. The operation explained above is a flow of the fold reinforcing processing (first time). If the roller unit 500 is reciprocatingly moved plural times to apply the fold reinforcing processing to one sheet bundle, the operation control for the roller unit 500 is repeated.

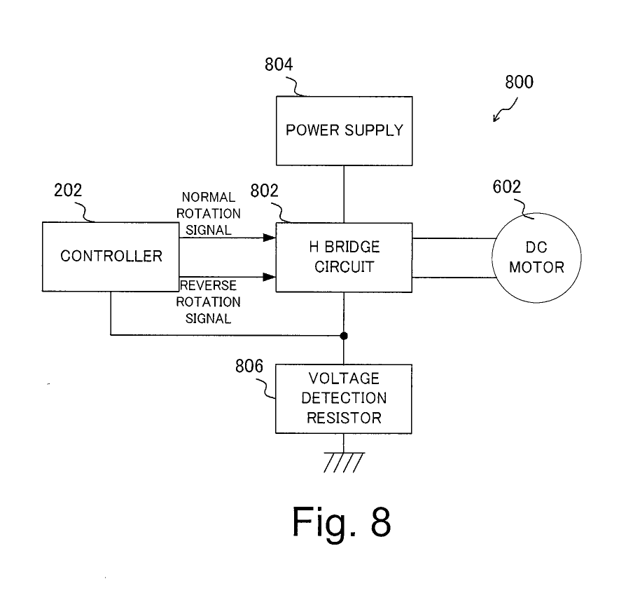

FIG. 8 is a block diagram for explaining the driving control for the roller unit 500. The sheet processing apparatus 200 includes a driving circuit 800 that moves the roller unit 500 in the fold direction of the sheet bundle. The driving circuit 800 includes the driving motor 602 and a control circuit that controls the driving motor 602. In this embodiment, the driving motor 602 that drives the roller unit 500 is a direct-current motor (hereinafter, DC motor). An H bridge circuit 802 functioning as a control circuit is connected to the DC motor 602. A power supply 804 is connected to the H bridge circuit 802. The H bridge circuit 802 makes it possible to change the rotating direction of the DC motor 602 by changing the direction of a voltage applied to the DC motor 602. The controller 202 is connected to the H bridge circuit 802. The controller 202 sends a normal rotation signal or a reverse rotation signal to the H bridge circuit 802 and controls the rotating direction of the driving motor 602, i.e., the driving of the roller unit 500. A voltage detection resistor 806 is connected to the H bridge circuit 802. In this embodiment, the controller 202 detects a voltage via the voltage detection resistor 806 to thereby measure an electric current flowing to the H bridge circuit 802. In other words, the controller 202 calculates a value of an electric current of the DC motor 602 functioning as the driving motor. Alternatively, the controller 202 calculates a value of an electric current flowing through the driving circuit 800 that drives the roller unit 500.

### Fold Reinforcement Control in the First Embodiment

In the fold reinforcing processing, when the roller unit 500 rides over a step at the end of the sheet bundle, a load on the roller unit 500 increases. In other words, the value of the electric current of the driving circuit 800 that drives the roller unit 500 increases. As the thickness of the sheet bundle increases, the value of the electric current flowing through the H bridge circuit 802 when the roller unit 500 rides over the end of the sheet bundle increases. Therefore, the sheet processing apparatus 200 in this embodiment controls the fold reinforcing processing on the basis of the value of the electric current flowing through the driving circuit 800 when the roller unit 500 rides over the end of the sheet bundle folded by the folding unit 258.

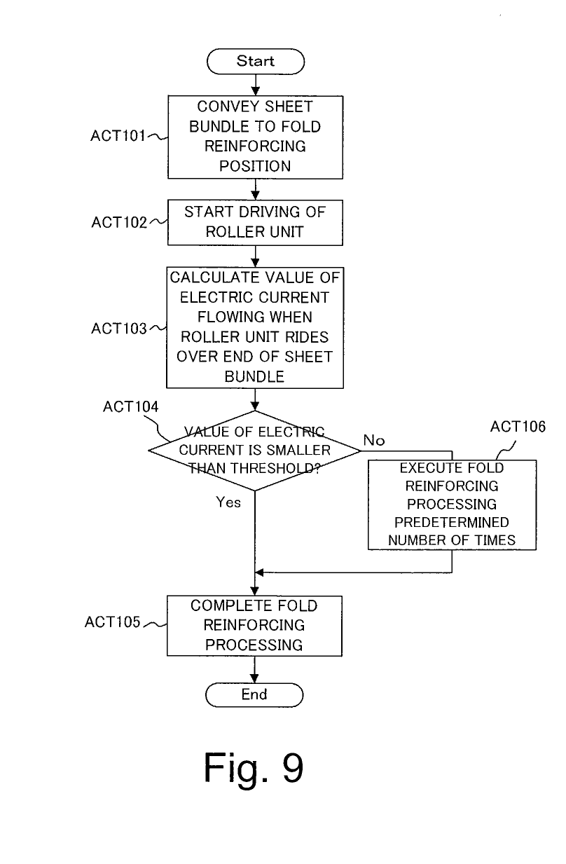

FIG. 9 is a flowchart for explaining the fold reinforcing processing by the sheet processing apparatus 200 in this embodiment. The sheet processing apparatus 200 measures a voltage applied to the driving circuit 800 when the roller unit 500 rides over the end of the sheet bundle folded by the folding unit 258 and calculates a value of an electric current. The sheet processing apparatus 200 controls the number of times of the fold reinforcing processing on the basis of the value of the electric current.

In ACT 101, the controller 202 controls the rotation of the folding roller motor, which drives the folding roller pair 262 of the folding unit 258, to convey the sheet bundle folded by the folding unit 258 to the fold reinforcing position. The controller 202 starts the driving of the roller unit 500 located in the home position (ACT 102).

The controller 202 measures, via the voltage detection resistor 806, a voltage applied to the driving circuit 800 when the roller unit 500 rides over the end of the sheet bundle and calculates a value of an electric current (ACT 103). The controller 202 determines whether the calculated value of the electric current is smaller than a threshold (ACT 104). After the roller unit 500 rides over the end of the sheet bundle, the controller 202 directly reciprocatingly moves the roller unit 500 and applies first fold reinforcing processing to the sheet bundle.

The value of the electric current flowing through the driving circuit 800 when the roller unit 500 rides over the end of the sheet bundle increases as the thickness of the sheet bundle increases. The threshold in this embodiment is an ideal value of an electric current experimentally calculated in advance. The threshold is stored in the memory 206 in, for example, a data format like a lookup table. The controller 202 acquires, from the image forming apparatus 100, sheet processing information such as a type of sheets to be processed and the number of sheets per one bundle. The controller 202 sets an appropriate threshold on the basis of the sheet processing information.

If the value of the electric current is smaller than the threshold set in advance (Yes in ACT 104), after executing the first fold reinforcing processing, the controller 202 ends the fold reinforcing processing without performing further reciprocating movement processing for the roller unit 500 (ACT 105).

On the other hand, if the value of the electric current exceeds the threshold set in advance (No in ACT 104), the controller 202 increases the number of times of reciprocating movement of the roller unit 500 (ACT 106), i.e., further performs the fold reinforcing processing a predetermined number of times. The predetermined number of times is the number of times of fold reinforcement equal to or larger than 1. The number of times of fold reinforcement may be the number of times experimentally calculated in advance and set or may be the number of times set and input by a user via the operation panel 112.

An example in which an additional number of times of fold reinforcement is set is explained above. However, naturally, a total number of times of fold reinforcement including the first fold reinforcement processing may be set. The threshold is not limited to one. For example, the number of times of fold reinforcement may be set for each of plural thresholds.

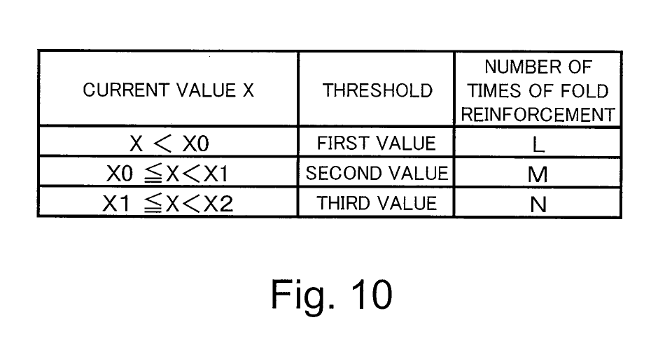

The number of times of fold reinforcement set for each of plural thresholds is shown in FIG. 10. In FIG. 10, a total number of times of fold reinforcement including the first fold reinforcement processing is set. For example, if a value of an electric current X is smaller than X0 (a first threshold), after performing the fold reinforcing processing L times ( ), the controller 202 discharges the sheet bundle. On the other hand, if the value of the electric current X is in a relation of X0≦X<X1 (a second threshold), the controller 202 reciprocatingly moves the roller unit 500 and performs the fold reinforcing processing M times (M>L). Alternatively, if the value of the electric current X is in a relation of X1≦X<X2 (a third threshold), the controller 202 reciprocatingly moves the roller unit 500 and performs the fold reinforcing processing N times ((N>M)). The user may set the threshold and the number of times of fold reinforcement via the operation panel 112. The numbers of times of fold reinforcement L, M, an N are not limited to N>M>L and may be the same number of times as long as the number of times is equal to or larger than 1.

With the sheet processing apparatus 200 in the embodiment explained above, a value of an electric current flowing through the driving circuit 800 when the roller unit 500 rides over the end of the sheet bundle is calculated. When the value of the electric current exceeds the threshold set in advance, the fold reinforcing processing by the roller unit 500 is added. Consequently, it is possible to set the sheet bundle to appropriate folding height.

### Second Embodiment

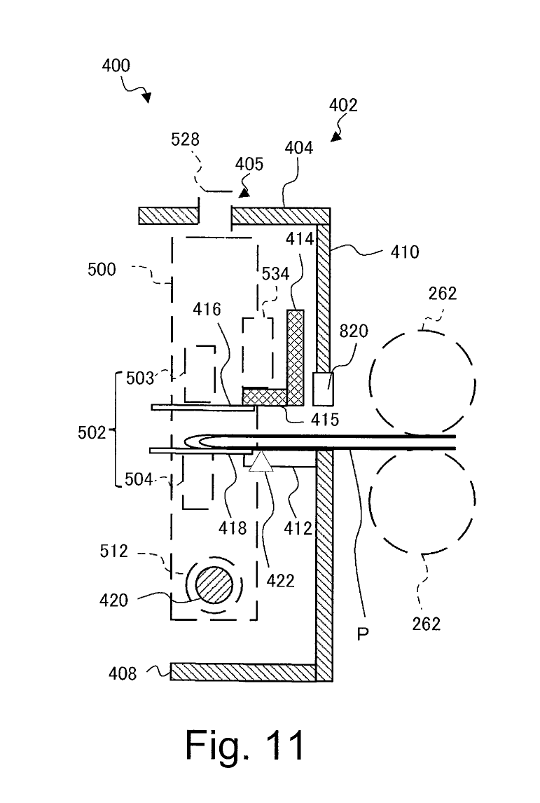

The sheet processing apparatus 200 in a second embodiment includes a detection sensor 820 for detecting the height of a folded sheet bundle. As shown in FIG. 11, the detection sensor 820 is arranged between the folding roller pair 262 and the roller unit 500. For example, the detection sensor 820 is attached to the frame 402 of the supporting section 400.

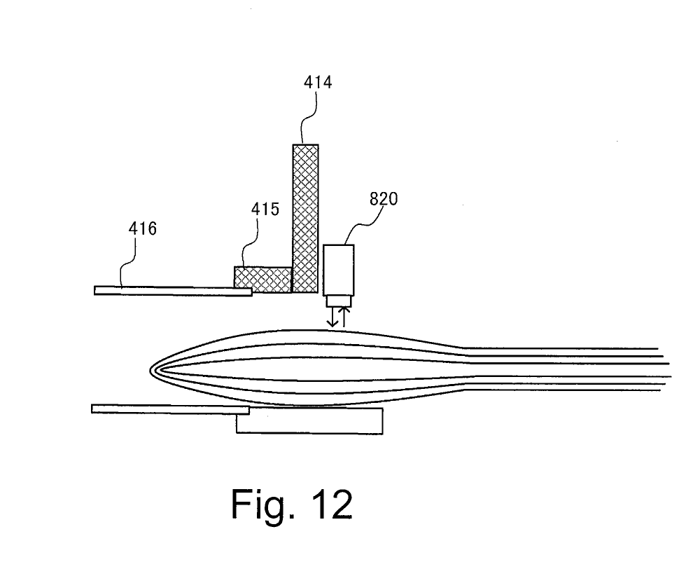

FIG. 12 is a schematic diagram for explaining the detection sensor 820. In FIG. 12, the roller unit 500 is not shown. The detection sensor 820 detects the height of folding of a sheet bundle (hereinafter, folding height). The detection sensor 820 may be a general displacement sensor of a device such as an optical type, an ultrasonic type, a laser focus type, or a contact type. For example, the detection sensor 820 detects, with the device, a physical change amount to the surface of the sheet bundle and calculates the change amount as a distance. According to the calculation, the detection sensor 820 can calculate a distance from the sensor to the sheet bindle and measure the folding height of the sheet bundle. The folding height of the sheet bundle means the thickness of the sheet bundle on which a fold is formed by the folding roller pair 262. The detection sensor 820 is desirably arranged in a position in the sheet conveying direction where the folding height of the sheet bundle changes when the fold of the sheet bundle is reinforced by the roller unit 500. For example, the detection sensor 820 is arranged in a position where the detection sensor 820 can detect a bulge of the sheet bundle folded by the folding roller pair 262.

### Fold Reinforcement Control in the Second Embodiment

The sheet processing apparatus 200 in this embodiment controls the fold reinforcing processing on the basis of the folding height of the sheet bundle.

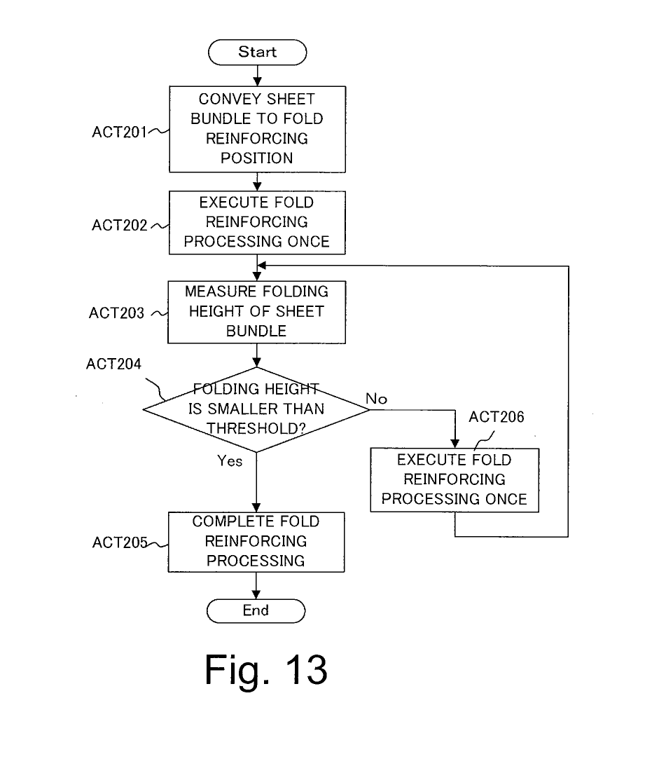

FIG. 13 is a flowchart for explaining the fold reinforcing processing by the sheet processing apparatus 200 in this embodiment. The sheet processing apparatus 200 measures the folding height of the sheet bundle folded by the folding unit 258. Alternatively, the sheet processing apparatus 200 measures the folding height of the sheet bundle after the roller unit 500 of the fold reinforcing unit 300 reciprocatingly moves along the fold of the sheet bundle and reinforces the fold. The sheet processing apparatus 200 determines, on the basis of the folding height of the sheet bundle, whether the fold reinforcing processing is executed.

In ACT 201, the controller 202 controls the rotation of the folding roller motor, which drives the folding roller pair 262 of the folding unit 258, to convey the sheet bundle folded by the folding unit 258 to the fold reinforcing position. The controller 202 reciprocatingly moves the roller unit 500 and applies first fold reinforcing processing to the sheet bundle (ACT 202). The first fold reinforcing processing means that the roller unit 500 reciprocatingly moves once along the fold of the sheet bundle to reinforce the fold. However, the first fold reinforcing processing is not limited to the fold reinforcing processing in which the roller unit 500 simply performs the reciprocating movement once. For example, as the first fold reinforcing processing, the reciprocating movement of the roller unit 500 may be performed plural times.

The controller 202 measures the folding height of the sheet bundle, the fold of which is reinforced by the roller unit 500, via the detection sensor 820 (ACT 203). The controller 202 determines whether the measured folding height of the sheet bundle is smaller than a threshold (ACT 204).

The folding height of the sheet bundle changes according to the number of sheets and a sheet type. Therefore, the threshold in this embodiment is ideal folding height experimentally calculated in advance. The threshold is stored in the memory 206 in, for example, a data format like a lookup table. The controller 202 acquires, from the image forming apparatus 100, sheet processing information such as a type of sheets to be processed and the number of sheets per one bundle. The controller 202 sets an appropriate threshold on the basis of the sheet processing information.

If the measured folding height of the sheet bundle is smaller than the threshold set in advance (Yes in ACT 204), after executing the first fold reinforcing processing, the controller 202 ends the fold reinforcing processing without performing further reciprocating movement processing for the roller unit 500 (ACT 205).

On the other hand, if the measured folding height of the sheet bundle exceeds the threshold set in advance (No in ACT 204), the controller 202 reciprocatingly moves the roller unit 500 and carries out second fold reinforcing processing (ACT 206). The controller 202 measures the folding height of the sheet bundle, the fold of which is reinforced by the roller unit 500, via the detection sensor 820 again (ACT 203). The controller 202 determines whether the measured folding height of the sheet bundle exceeds the threshold (ACT 204). In the second fold reinforcing processing, as in the first fold reinforcing processing, the roller unit 500 may be reciprocatingly moved once or may be reciprocatingly moved plural times.

In the above explanation, the fold reinforcing processing is applied once in ACT 202 to the sheet bundle folded by the folding unit 258 (the first fold reinforcing processing). However, the sheet processing apparatus 200 in this embodiment is not limited to this. For example, the controller 202 does not have to perform the processing in ACT 202. Specifically, at a point when the sheet bundle folded by the folding unit 258 is conveyed to the fold reinforcing unit 300, the controller 202 may measure the folding height of the sheet bundle folded by the folding unit 258, determine whether the measured folding height of the sheet bundle exceeds the threshold, and determine, on the basis of a result of the determination, whether the fold reinforcing processing is performed.

According to the embodiment explained above, the sheet processing apparatus 200 includes the folding unit 258 that folds a sheet bundle including plural sheets to form a fold and the fold reinforcing roller 502 that nips the fold of the sheet bundle having the fold formed thereon and conveyed to the fold reinforcing position, reciprocatingly moves along the direction of the fold, and reinforces the fold of the sheet bundle. The sheet processing apparatus 200 includes the detection sensor 820 that is arranged between folding unit 258 and the fold reinforcing roller 502 along the sheet conveying direction and measures the folding height of the sheet bundle present in the fold reinforcing position. The controller (the controller) 202 of the sheet processing apparatus 200 reciprocatingly moves the fold reinforcing roller on the basis of a result of the measurement by the detection sensor 820.

If the folding height of the sheet bundle exceeds the threshold, the controller 202 of the sheet processing apparatus 200 reciprocatingly moves the fold reinforcing roller 502. The controller 202 of the sheet processing apparatus 200 reciprocatingly moves the fold reinforcing roller 502 until the folding height of the sheet bundle decreases to be smaller than the threshold. If the folding height of the sheet bundle is smaller than the threshold, the controller 202 discharges the sheet bundle.

With the sheet processing apparatus 200 in the embodiment explained above, the actual folding height of the sheets is measured. When the folding height exceeds the threshold set in advance, the fold reinforcing processing by the roller unit 500 is added. Consequently, it is possible to set the sheet bundle to appropriate folding height.

### Modification of the Second Embodiment

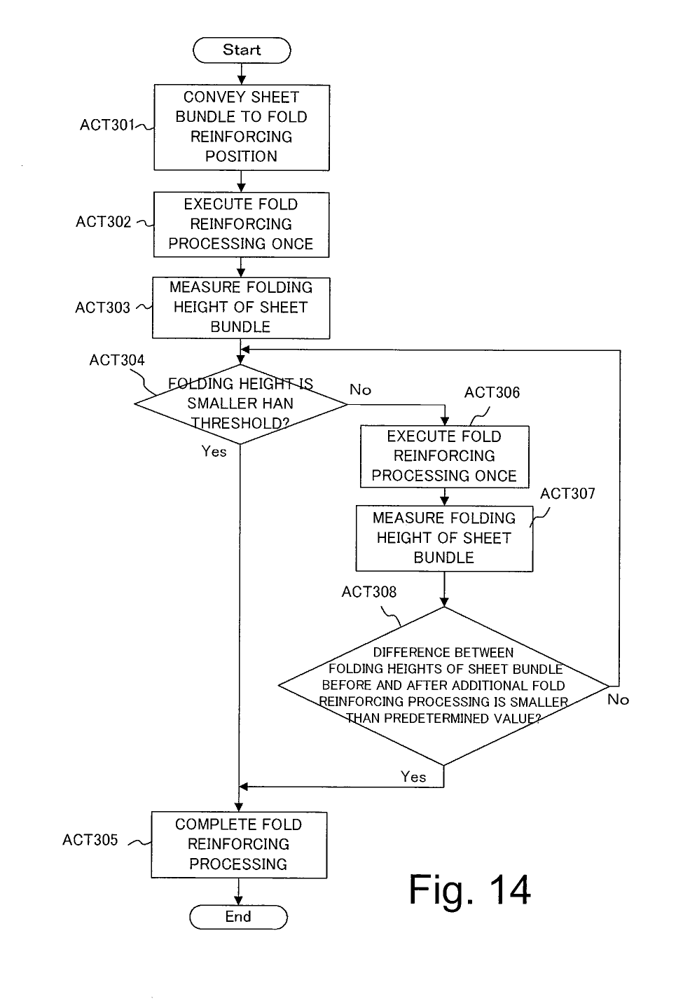

Fold reinforcement control in a modification of the second embodiment is explained. In this embodiment, information concerning the folding heights of the sheet bundle before the application of the fold reinforcing processing and after the application of the fold reinforcing processing is further used. FIG. 14 is a flowchart for explaining the fold reinforcing processing by the sheet processing apparatus 200 in this modification.

In ACT 301, the controller 202 controls the rotation of the folding roller motor, which drives the folding roller pair 262 of the folding unit 258, to convey the sheet bundle folded by the folding unit 258 to the fold reinforcing position. The controller 202 reciprocatingly moves the roller unit 500 and applies the first fold reinforcing processing to the sheet bundle as in the first embodiment (ACT 302).

The controller 202 measures the folding height of the sheet bundle, the fold of which is reinforced by the roller unit 500, via the detection sensor 820 (ACT 303). The controller 202 determines whether the measured folding height of the sheet bundle is smaller than the threshold (ACT 304). If the measured folding height of the sheet bundle is smaller than the threshold set in advance (Yes in ACT 304), the controller 202 ends the fold reinforcing processing without performing further reciprocating movement processing for the roller unit 500 (ACT 305).

On the other hand, if the measured folding height of the sheet bundle exceeds the threshold set in advance (No in ACT 304), the controller 202 reciprocatingly moves the roller unit 500 and carries out the fold reinforcing processing again (second fold reinforcing processing) (ACT 306). The controller 202 measures the folding height of the sheet bundle, the fold of which is reinforced by the roller unit 500, via the detection sensor 820 again (ACT 307).

In ACT 308, the controller 202 compares the folding height of the sheet bundle measured in ACT 303 and the folding height of the sheet bundle measured in ACT 307. Specifically, the controller 202 compares the folding height of the sheet bundle subjected to the first fold reinforcing processing in ACT 303 and the folding height of the sheet bundle subjected to the second fold reinforcing processing in ACT 306.

If a difference between the folding heights of the sheet bundle before and after the additional fold reinforcing processing (the second fold reinforcing processing) is carried out in ACT 306 is larger than a predetermined value (No in ACT 308), the processing by the controller 202 returns to the processing in Act 304. On the other hand, if the difference between the folding heights of the sheet bundle before and after the additional fold reinforcing processing is carried out is smaller than the predetermined value (Yes in ACT 308), even if the measured folding height of the sheet bundle is larger than the threshold, the controller 202 ends the fold reinforcing processing without performing further reciprocating movement processing for the roller unit 500 (ACT 305). If the difference between the folding heights of the sheet bundle before and after the additional fold reinforcing processing is carried out is smaller than the predetermined value, this means that the folding height does not change much irrespective of the fact that the additional fold reinforcing processing is carried out. Therefore, thereafter, even if the fold reinforcing processing is additionally applied, it is determined that the folding height does not change much. Therefore, the controller 202 ends the fold reinforcing processing. With the sheet processing apparatus 200 in this embodiment, it is possible to realize effects same as the effects in the first embodiment and appropriately prevent a processing time from excessively increasing.

### Third Embodiment

The sheet processing apparatus 200 in a third embodiment determines whether execution of fold reinforcing processing by the roller unit 500 of the fold reinforcing unit 300 is possible.

The roller unit 500 usually moves along a fold of a sheet bundle folded by the folding unit 258. Specifically, the fold reinforcing roller 502 of the roller unit 500 moves in the width direction orthogonal to a sheet conveying direction of the folded sheet bundle and, after riding over an end of the sheet bundle, moves along the fold. The fold reinforcing roller 502 reinforces the fold with a strong pressing force. For example, if an actual sheet is thick paper or the like irrespective of the fact that sheet processing information from the image forming apparatus 100 indicates that a type of sheets to be processed is plain paper, depending on the number of sheets, it is likely that the folding height of the sheet bundle exceeds a range of specifications. In this case, it is likely that the fold reinforcing roller 502 of the roller unit 500 may be unable to ride over the end of the sheet bundle and stops.

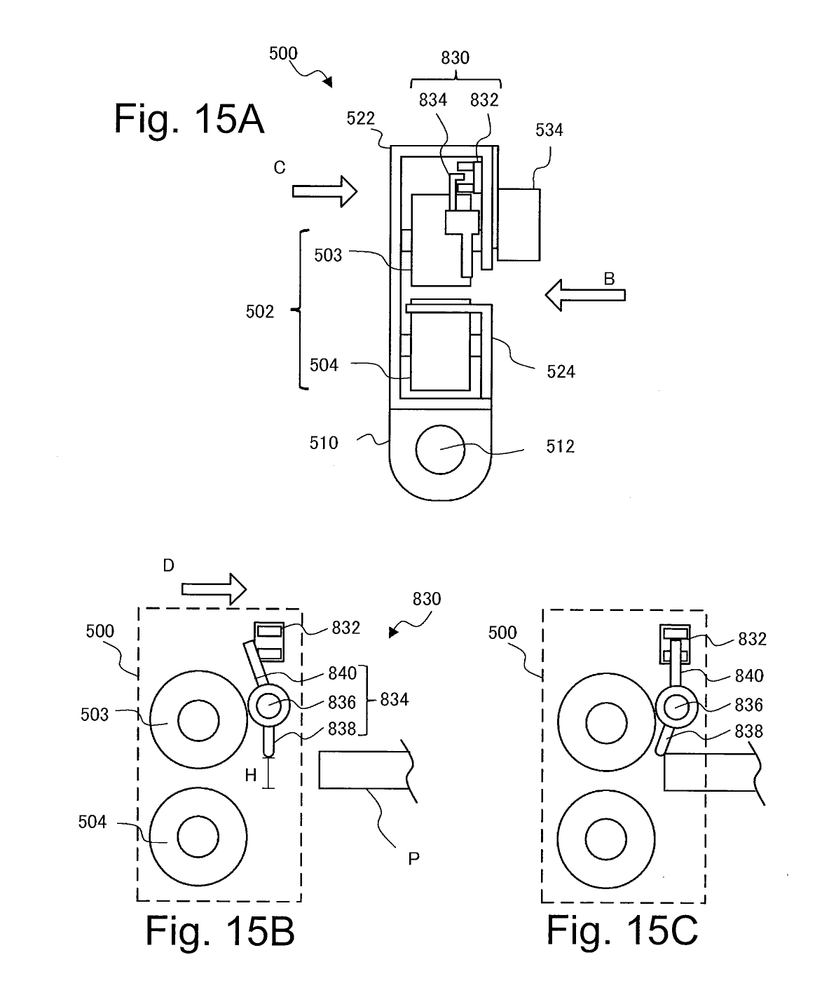

Therefore, the sheet processing apparatus 200 in this embodiment determines whether the fold reinforcing processing for the sheet bundle folded by the folding unit 258 can be executed before the fold reinforcing roller 502 of the roller unit 500 rides over the sheet bundle. FIGS. 15A to 15C are schematic diagrams for explaining the roller unit 500 in the third embodiment. Components same as the components in the other embodiments are denoted by the same reference numerals and signs and explanation of the components is omitted.

FIG. 15A is a schematic diagram for explaining the roller unit 500 in the third embodiment. In FIG. 15A, the sheet bundle folded by the folding unit 258 is conveyed in an arrow B direction. The roller unit 500 includes a detection unit 830 for determining whether the fold reinforcing processing for the sheet bundle can be executed. The detection unit 830 is attached to the upper frame 522 of the roller unit 500. The detection unit 830 includes a sensor 832 including a light emitting section and a light receiving section and an actuator 834.

FIGS. 15B and 15C are schematic diagrams of the roller unit 500 viewed from an arrow C direction in FIG. 15A. In FIGS. 15B and 15C, for convenience of explanation, the unit supporting section 510, the upper frame 522, and the lower frame 524 are not shown.

In FIG. 15B, the roller unit 500 moves from the home position, which is a standby position, in the fold direction of the sheet bundle folded by the folding unit 258 (an arrow D direction). The detection unit 830 is located further on the sheet bundle side than the fold reinforcing roller 502 in a state in which the roller unit 500 stays on standby in the home position.

The actuator 834 of the detection unit 830 includes a pivoting shaft 836, a first member 838 that projects from the pivoting shaft 836, and a second member 840 that also projects from a position apart from the first member 838 in the circumferential direction of the pivoting shaft 836. If the folding height of a sheet bundle P conveyed to the fold reinforcing position is equal to or larger than height H, the first member 838 comes into contact with the end of the sheet bundle. The second member 840 includes, at the distal end, a protrusion perpendicularly to a projecting direction. The roller unit 500 moves in the arrow D direction in a state in which the first member 838 is in contact with the end of the sheet bundle, whereby the second member 840 pivots in the clockwise direction with the pivoting shaft 836 as a fulcrum. According to the pivoting of the second member 840, the protrusion at the distal end of the second member 840 blocks the section between the light emitting section and the light receiving section of the sensor 832. As shown in FIGS. 15B and 15C, the roller unit 500 moves from the home position, which is the standby position, in the fold direction of the sheet bundle. The detection unit 830 moves in the fold direction of the sheet bundle together with the roller unit 500.

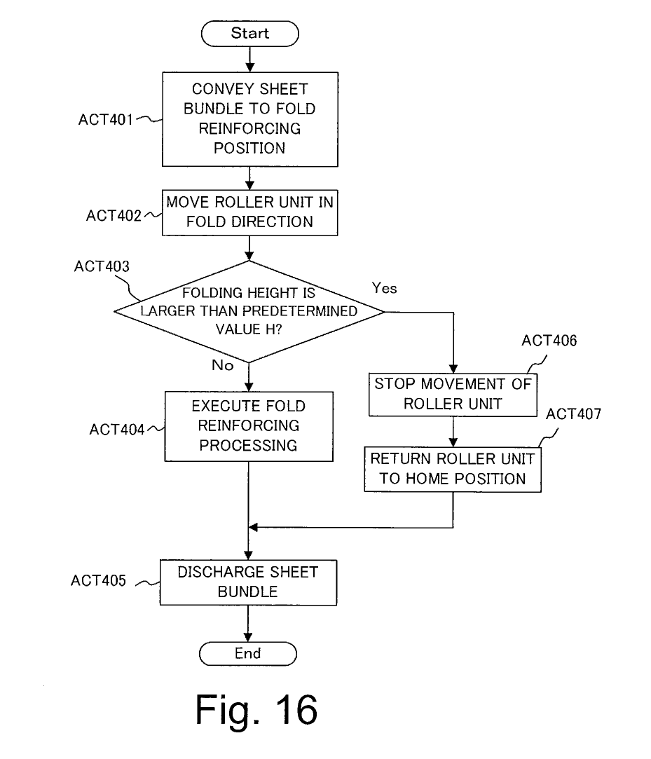

FIG. 16 is a flowchart for explaining the control by the sheet processing apparatus 200 in the third embodiment.

In ACT 401, the controller 202 conveys the sheet bundle to the fold reinforcing position via the folding roller pair 262. When the sheet bundle is conveyed to the fold reinforcing position, the controller 202 starts the fold reinforcing processing by the roller unit 500 and moves the roller unit 500 from the home position in the fold direction.

In ACT 403, the controller 202 determines whether the folding height of the sheet bundle exceeds the predetermined value H. For example, the controller 202 detects an ON or OFF signal from the detection unit 830.

The detection unit 830 attached to the roller unit 500 reaches the ends in the width direction of the sheet bundle P earlier than the fold reinforcing roller pair 502. If the folding height of the sheet bundle P is equal to or smaller than the predetermined value H, the first member 838 does not come into contact with the end and the upper surface of the sheet bundle. Therefore, the signal of the detection unit 830 indicates ON. On the other hand, if the folding height of the sheet bundle P exceeds the predetermined value H, the first member 838 comes into contact with the end of the sheet bundle. When the first member 838 comes into contact with the end of the sheet bundle, the second member 840 pivots about the pivoting shaft 836 and the protrusion blocks the section between the light emitting section and the light receiving section of the sensor 832. Therefore, the signal of the detection unit 830 indicates OFF.

If the folding height of the sheet bundle does not exceed the predetermined value H (No in ACT 403), i.e., if the detection unit 830 is ON, the controller 202 continues the movement in the fold direction of the roller unit 500 and executes the fold reinforcing processing (ACT 404). When the fold reinforcing processing is completed, the controller 202 discharges the sheet bundle (ACT 405).

On the other hand, if the folding height of the sheet bundle exceeds the predetermined value H (Yes in ACT 403), i.e., if the detection unit 830 is OFF, the controller 202 stops the movement in the fold direction of the roller unit 500 (ACT 406). For example, the controller 202 stops the movement in the fold direction of the roller unit 500 before the fold reinforcing roller 502 hits the end of the sheet bundle. In ACT 407, the controller 202 returns the roller unit 500 to the home position. Subsequently, the controller 202 discharges the sheet bundle (ACT 405). Specifically, if the folding height of the sheet bundle exceeds the predetermined value H, the controller 202 discharges the sheet bundle without executing the fold reinforcing processing.

The controller 202 informs, via the operation panel 112, a user that the controller 202 discharges the sheet bundle without executing the fold reinforcing processing.

With the sheet processing apparatus 200 in the embodiment explained above, the roller unit 500 may be unable to climb over the sheet bundle and the sheet bundle is prevented from stopping to cause a jam. Therefore, the user does not need to perform operation such as jam release. As a result, convenience for the user is high.

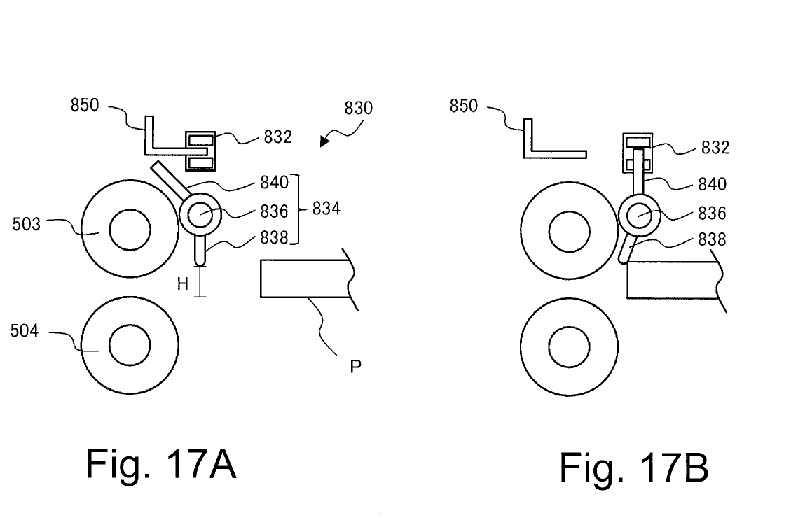

The detection unit 830 may be configured to not only detect the folding height of the sheets but also detect the home position of the roller unit 500. For example, as shown in FIGS. 17A and 17B, a protrusion 850 may be provided in a not-shown supporting section. If the roller unit 500 is present in the home position, the protrusion 850 may block the section between the light emitting section and the light receiving section of the sensor 832 of the detection unit 830. When the roller unit 500 starts movement in the fold direction, the sensor 832 that moves together with the roller unit 500 stops detecting the protrusion 850. If the folding height of the sheet bundle exceeds the predetermined value H, subsequently, the sensor 832 that stops detecting the protrusion 850 detects the protrusion of the second member 840 of the actuator 834. The sheet processing apparatus 200 detects the home position of the roller unit 500 using the detection unit 830 instead of the detecting member 560. Therefore, it is possible to reduce the number of sensors.

### Fourth Embodiment

The sheet processing apparatus 200 in a fourth embodiment measures the thickness of a sheet bundle in a state in which the sheet bundle is pressed by a folding roller pair and controls fold reinforcing processing on the basis of the thickness of the sheet bundle.

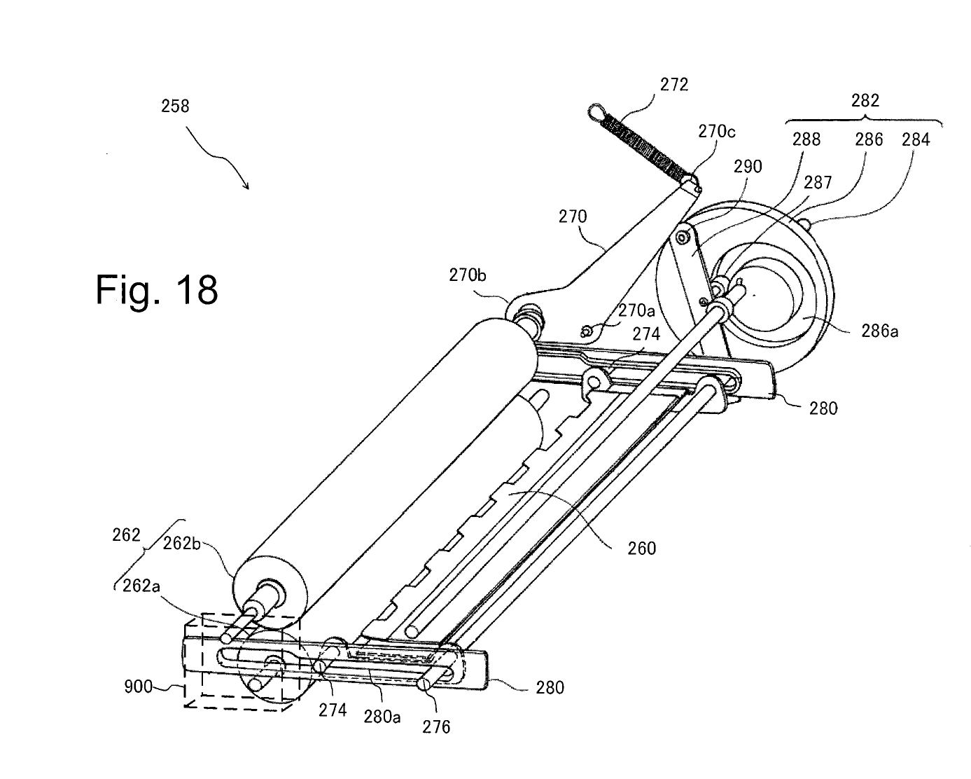

FIG. 18 is a schematic perspective view for explaining the overall structure of the folding unit 258. In FIG. 18, an arm 270 and a driving section 282 including a groove cam 286 on one side (the near side in the figure) are not shown.

The folding unit 258 includes the folding roller pair 262 that folds the sheet bundle into two, the folding plate 260 that pushes the sheet bundle into the nip portion of the folding roller pair 262, and a guide member 280 that holds the folding plate 260 to be movable toward the folding roller pair 262.

The folding roller pair 262 includes a fixed roller 262a and a movable roller 262b. The fixed roller 262a is fixedly arranged in a not-shown apparatus frame to be rotatable via a shaft. The movable roller 262b is rotatably supported at one end 270b of the arm 270 supported in the not-shown apparatus frame to be pivotable about a fulcrum 270a. The movable roller 262b can come into contact with and separate from the fixed roller 262a. A spring 272 is attached to the other end 270c of the arm 270. A movable roller 262b urged by the arm 270 that pivots about the fulcrum 270a comes into press contact with the fixed roller 262a and forms a nip portion. The fixed roller 262a and the movable roller 262b are rotated by a not-shown driving motor. A detection unit 900 explained below is arranged at one end in a rotating shaft direction of the folding roller 262.

The folding plate 260 includes a protrusion 274 and a shaft 276. The folding plate 260 is slidably held by the guide member 280 via the protrusion 274 and the shaft 276. The guide member 280 slidably supports the protrusion 274 and the shaft 276 and includes a guide groove 280a for guiding the folding plate 260 to the nip portion of the folding roller pair 262. The driving sections 282 that slide the folding plate 260 are connected to both the ends of the shaft 276.

The driving section 282 includes a cam shaft 284, the groove cam 286 that rotates about the cam shaft 284, and a link member 288. The groove cam 286 includes a groove 286a. In the groove 286a of the groove cam 286, a roller 287 such as a roller follower functioning as a contact piece is rotatably guided. The roller 287 is attached to the link member 288. A link pivoting shaft 290 is provided at one end of the link member 288. The link pivoting shaft 290 is attached to the apparatus frame. The groove cam 286 is rotated by a not-shown driving motor connected to one end of the cam shaft 284. When the roller 287 is guided along the groove 286a according to the rotation of the groove cam 286, the link member 288 repeats reciprocating movement like a pendulum about the link pivoting shaft 290 according to the eccentricity of the groove 286a. According to the reciprocating movement of the link member 288, the folding plate 260 slides along the guide groove 280a of the guide member 280.

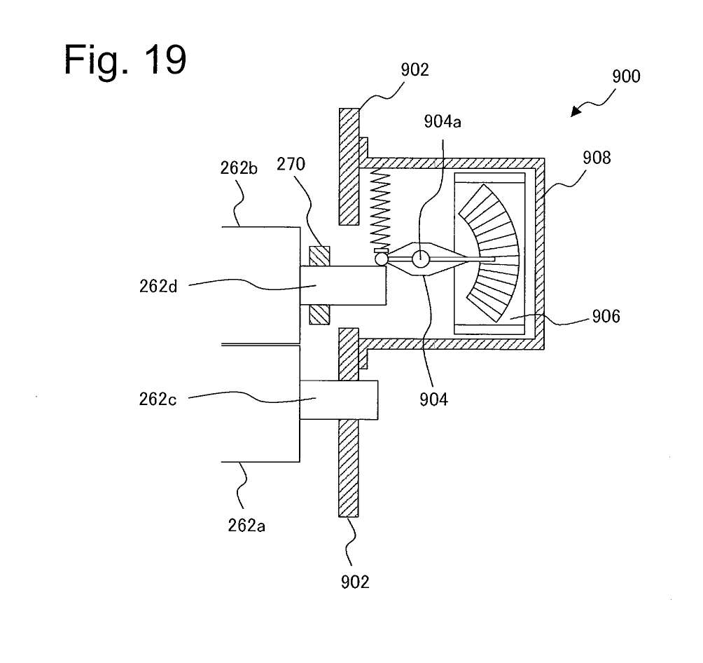

FIG. 19 is a schematic diagram for explaining the detection unit 900. In FIG. 19, the fixed roller 262a is supported by an apparatus frame 902 to be rotatable via a rotating shaft 262c. The movable roller 262b is supported by the arm 270, which is pivotably supported by the apparatus frame 902, via a rotating shaft 262d. Therefore, the movable roller 262b can move in the up down direction in FIG. 19.

The detection unit 900 is arranged on one end side of the rotating shaft 262d of the movable roller 262b. The detection unit 900 measures a movement amount in a contact and separation direction of the movable roller 262b. For example, in a state in which the folding roller pair 262 does not fold the sheet bundle, the movable roller 262b and the fixed roller 262a form a nip. On the other hand, when the folding roller pair 262 folds the sheet bundle, the movable roller 262b moves in the upward direction in the figure by the thickness of the sheet bundle pressed by the folding roller pair 262. The detection unit 900 measures the movement amount of the movable roller 262b. In other words, if the movable roller 262b in contact with the fixed roller 262a nips and presses the sheet bundle, the detection unit 900 measures a displacement amount of movement in a direction away from the fixed roller 262a.

The detection unit 900 includes an actuator 904, an encoder 906, and a frame 908 that supports the actuator 904 and the encoder 906. One end of the actuator 904 is urged to the rotating shaft 262d of the movable roller 262b by a spring 910. When the movable roller 262b moves in the direction away from fixed roller 262a, one end of the actuator 904 is displaced in the moving direction of the movable roller 262b by the rotating shaft 262d. In other words, the actuator 904 pivots about a fulcrum 904a. The encoder 906 reads the position of the other end (the distal end) of the actuator 904. Specifically, the controller 202 measures the movement amount (the displacement amount) of the movable roller 262b on the basis of a signal from the encoder 906. In other words, the controller 202 measures the thickness of the sheet bundle in a state in which the sheet bundle is pressed by the folding roller pair.

### Fold Reinforcement Control in the Fourth Embodiment

The sheet processing apparatus 200 in this embodiment controls the fold reinforcing processing on the basis of the movement amount of the movable roller 262b measured by the detection unit 900.

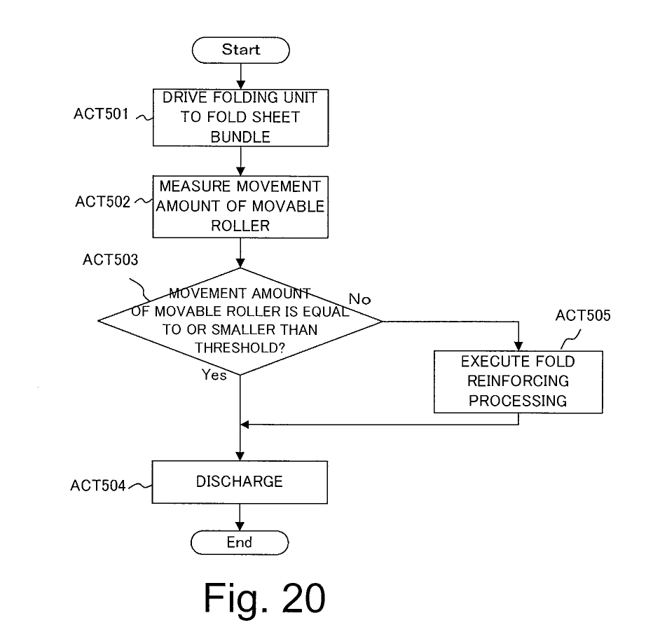

FIG. 20 is a flowchart for explaining the fold reinforcing processing by the sheet processing apparatus 200 in this embodiment. The sheet processing apparatus 200 drives the folding unit 258 to fold the sheet bundle. The sheet processing apparatus 200 measures the movement amount of the movable roller 262b that moves when the folding unit 258 folds the sheet bundle. The sheet processing apparatus 200 determines, on the basis of the movement amount of the movable roller 262b, whether the fold reinforcing processing is executed.

In ACT 501, the controller 202 drives the folding unit 258 to fold the sheet bundle. In ACT 502, the controller 202 measures, via the detection unit 900, the movement amount of the movable roller 262b that moves when the folding unit 258 nips the sheet bundle. The controller 202 determines whether the measured movement amount of the movable roller 262b is smaller than a threshold set in advance (ACT 503).

If the measured movement amount of the movable roller 262b is smaller than the threshold set in advance (YES in ACT 503), the controller 202 discharges the sheet bundle folded by the folding unit 258 without performing the fold reinforcing processing (ACT 504).

On the other hand, if the measured movement amount of the movable roller 262b exceeds the threshold set in advance (No in ACT 503), the controller 202 reciprocatingly moves the roller unit 500 and carries out the fold reinforcing processing (ACT 505).

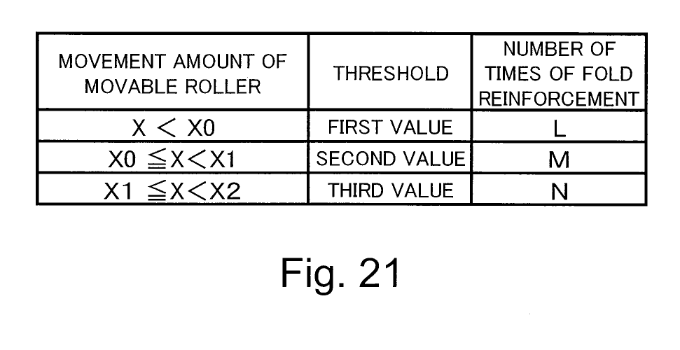

The threshold in this embodiment is a value experimentally calculated in advance. The threshold is stored in the memory 206 in a data format like a lookup table. The threshold is not limited to one. For example, as shown in FIG. 21, the number of times fold reinforcement may be set for each of plural thresholds.

For example, if a movement amount X of the movable roller 262b is smaller than X0 (a first threshold), the controller 202 discharges the sheet bundle folded by the folding unit 258 without performing the fold reinforcing processing. On the other hand, if the movement amount X of the movable roller 262b is in a relation of X0≦X<X1 (a second threshold), the controller 202 reciprocatingly moves the roller unit 500 and performs the fold reinforcing processing M times. Alternatively, if the movement amount X of the movable roller 262b is in a relation of X1≦X<X2 (a third threshold), the controller 202 reciprocatingly moves the roller unit 500 and performs the fold reinforcing processing N times ((N>M)). A user may set the threshold and the number of times of fold reinforcement via the operation panel 112. The numbers of times of fold reinforcement M and N are not limited to N>M and may be the same number of times of fold reinforcement as long as the number of times of fold reinforcement is larger than 1.

The sheet processing apparatus 200 in the fourth embodiment includes the fixed roller 262a of the fold roller pair 262 and the movable roller 262b that is arranged to be capable of coming into contact with and separating from the fixed roller 262a, nips and presses a sheet bundle including plural sheets in conjunction with the fixed roller 262a, and forms a fold on the sheet bundle. The sheet processing apparatus 200 includes the fold reinforcing roller 502 that nips the fold of the sheet bundle having the fold formed thereon and conveyed to the fold reinforcing position, reciprocatingly moves along the direction of the fold, and reinforces the fold of the sheet bundle. The sheet processing apparatus 200 includes the detection unit 900 that measures the movement amount of the movable roller 262b in contact with the fixed roller 262a in the direction away from the fixed roller 262a when the movable roller 262b nips and presses the sheet bundle. The controller (the controller) 202 of the sheet processing apparatus 200 reciprocatingly moves the fold reinforcing roller on the basis of a result of the measurement by the detection unit 900. Specifically, if the movement amount of the movable roller 262b exceeds the threshold, the controller 202 reciprocatingly moves the fold reinforcing roller 502. For example, if the movement amount of the movable roller 262b is smaller than the threshold, the controller 202 does not reciprocatingly move the fold reinforcing roller 502.

With the sheet processing apparatus 200 in the fourth embodiment, the thickness of the sheet bundle in a state in which the sheet bundle is pressed by the folding roller pair 262 is measured. The fold reinforcing processing by the roller unit 500 is performed on the basis of the thickness of the sheet bundle. Consequently, it is possible to perform appropriate fold reinforcing processing.

### Fifth Embodiment

Fold reinforcement control in a fifth embodiment is explained. In the fourth embodiment, the movement amount (the displacement amount) of the movable roller 262b of the folding unit 258 is measured. However, in the fifth embodiment, when the roller unit 500 performs the fold reinforcing processing, the folding height of a sheet bundle is calculated by measuring the movement amount (the displacement amount) of the conveyance guide 414 that presses, from above, a sheet bundle conveyed to a fold reinforcing position.

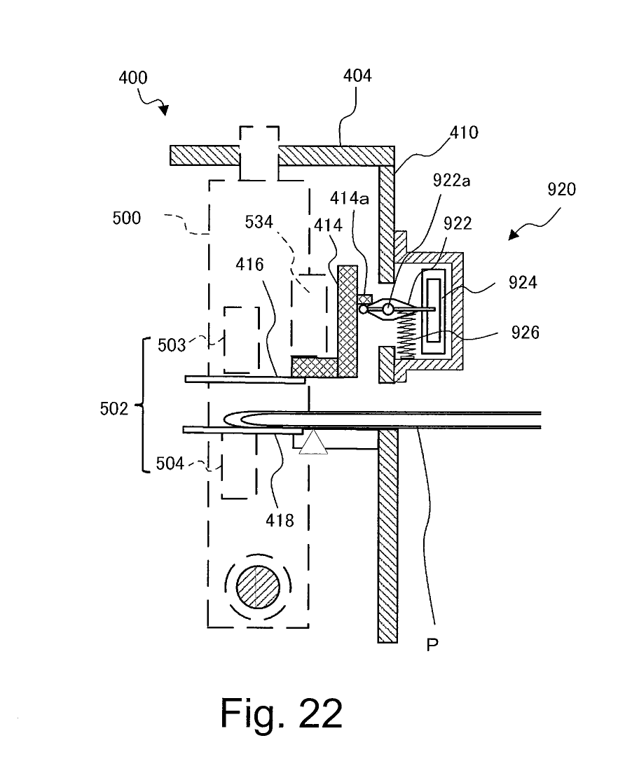

FIG. 22 is a schematic perspective view for explaining a detection unit in the fifth embodiment. In this embodiment, a detection unit 920 measures the displacement amount of the conveyance guide 414 that presses, from above, the sheet bundle conveyed to the fold reinforcing position. The detection unit 920 includes an actuator 922 and an encoder 924. A spring 926 is attached to the actuator 922. The actuator 922 pivots about a fulcrum 922a. One end of the actuator 922 is urged to a protrusion 414a provided in the conveyance guide 414.

As explained above, the upper link member 530 of the roller unit 500 presses the conveyance guide 414 downward with the conveyance guide roller 534 during the fold reinforcing processing. According to this operation, the conveyance guide 414 is displaced downward and presses the sheet bundle from above. When the conveyance guide 414 is displaced downward, one end of the actuator 922 is displaced in the moving direction of the conveyance guide 414 by the protrusion 414a. In other words, the actuator 922 pivots about the fulcrum 922a. The encoder 924 reads the position of the other end (the distal end) of the actuator 922. The controller 202 measures the displacement amount of the conveyance guide 414 on the basis of a signal from the encoder 924. The controller 202 calculates the thickness of the sheet bundle by measuring the displacement amount of the conveyance guide 414.

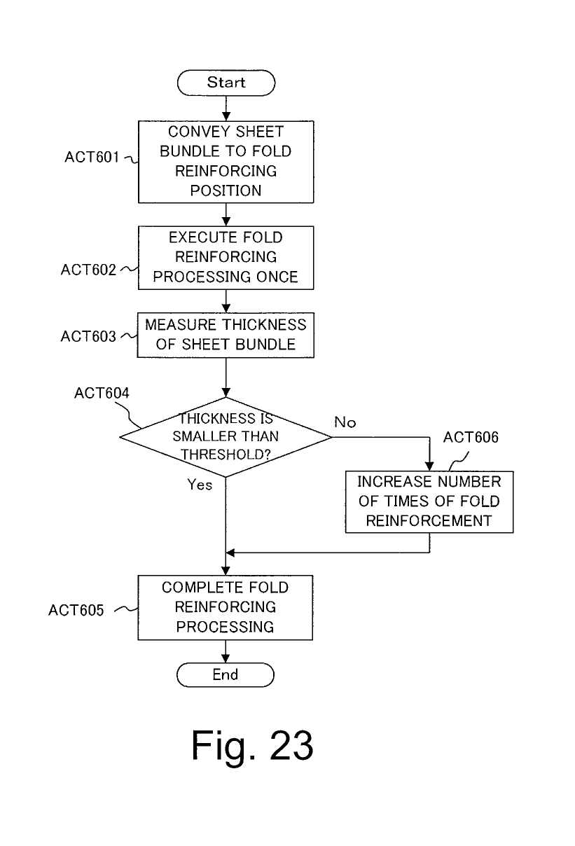

FIG. 23 is a flowchart for explaining the fold reinforcing processing by the sheet processing apparatus 200 in the fifth embodiment. In ACT 601, the controller 202 controls the rotation of the folding roller motor, which drives the folding roller pair 262 of the folding unit 258, to convey the sheet bundle folded by the folding unit 258 to the fold reinforcing position. The controller 202 reciprocatingly moves the roller unit 500 and applies first fold reinforcing processing to the sheet bundle (ACT 602).

The controller 202 measures the displacement amount of the conveyance guide 414 via the detection sensor 900. Specifically, the controller 202 measures the thickness of the sheet bundle pressed by the roller unit 500 and the conveyance guide 414 (ACT 603). The controller 202 determines whether the measured thickness of the sheet bundle is smaller than a threshold set in advance (ACT 604). If the measured thickness of the sheet bundle is smaller than the threshold set in advance (YES in ACT 604), the controller 202 ends the fold reinforcing processing (ACT 605).

On the other hand, if the measured thickness of the sheet bundle exceeds the threshold set in advance (No in ACT 604), the controller 202 increases the number of times the roller unit 500 is reciprocatingly moved (ACT 605).

The threshold in this embodiment is a value experimentally calculated in advance. The threshold is stored in the memory 206 in a data format like a lookup table. The threshold is not limited to one. For example, as in the first embodiment, the number of times fold reinforcement may be set for each of plural thresholds.

For example, if the thickness of the sheet bundle is smaller than X0 (a first threshold), the controller 202 discharges the sheet bundle without performing further fold reinforcing processing. On the other hand, if the thickness of the sheet bundle is in a relation of X0≦X<X1 (a second threshold), the controller 202 performs the fold reinforcing processing M times. Alternatively, if the thickness of the sheet bundle is in a relation of X1≦X<X2 (a third threshold), the controller 202 performs the fold reinforcing processing N times ((N>M)). A user may set the threshold and the number of times of fold reinforcement via the operation panel 112. The numbers of times of fold reinforcement M and N are not limited to N>M and may be the same number of times of fold reinforcement as long as the number of times of fold reinforcement is larger than 1.

With the sheet processing apparatus 200 in the fifth embodiment, the thickness of the sheet bundle in a state in which the sheet bundle is pressed by the fold reinforcing unit 300 is measured. The fold reinforcing processing by the roller unit 500 is performed on the basis of the thickness of the sheet bundle. Consequently, it is possible to perform appropriate fold reinforcing processing.

In this embodiment, the conveyance guide 414 that falls in association with the movement of the fold reinforcing unit 300 is explained. However, this is not a limitation. For example, the up and down movement of the conveyance guide 414 may be actively performed using another driving source such as a solenoid. In this case, it is possible to measure the thickness of the sheet bundle before starting the fold reinforcing processing.

According to at least one of the embodiments explained above, it is possible to perform more appropriate fold reinforcing processing.

An entity that executes the operations in the embodiments is an entity related to a computer such as hardware, a complex of the hardware and software, the software, and the software being executed. The entity that executes the operations is a process executed on a processor, the processor, an object, an execution file, a thread, a computer program, and the computer but is not limited to these. The process or the thread may be caused to play plural entities that execute the operations.

While certain embodiments have been described, these embodiments have been presented by way of example only, and are not intended to limit the scope of invention. Indeed, the novel apparatus described herein may be embodied in a variety of other forms; furthermore, various omissions, substitutions and changes in the form of the apparatus described herein may be made without departing from the spirit of the inventions. The accompanying claims and their equivalents are intended to cover such forms or modifications as would fall within the scope and spirit of the inventions.

What is claimed is:

1. A sheet processing apparatus comprising:
a folding unit configured to fold a sheet bundle including plural sheets to form a fold;
a fold reinforcing roller configured to nip the fold of the sheet bundle having the fold formed thereon and conveyed to a fold reinforcing position, reciprocatingly move along a direction of the fold, and reinforce the fold of the sheet bundle;
a driving circuit configured to drive the fold reinforcing roller along the direction of the fold; and
a controller configured to control a number of times of the reciprocating movement of the fold reinforcing roller on the basis of a value of an electric current of the driving circuit flowing when the fold reinforcing roller that starts driving from a standby position rides over an end of the sheet bundle.

2. The apparatus according to claim 1, wherein, if the value of the electric current is smaller than a threshold, the controller reciprocatingly moves the fold reinforcing roller a first number of times and, if the value of the electric current exceeds the threshold, the controller reciprocatingly moves the fold reinforcing roller a second number of times larger than the first number of times.

3. The apparatus according to claim 2, wherein
the threshold is plural thresholds to which different numbers of times of fold reinforcement are set, and
the controller determines a relevant threshold out of the plural threshold on the basis of the value of the electric current and reciprocatingly moves the fold reinforcing roller a number of times of fold reinforcement set to the relevant threshold.

4. The apparatus according to claim 3, further comprising an operation section for setting a number of times of fold reinforcement to the threshold.

5. The apparatus according to claim 2, wherein the controller calculates a value of an electric current flowing through the driving circuit.

6. A sheet folding method executed in a sheet processing apparatus including a folding unit that folds a sheet bundle, a fold reinforcing roller, and a driving circuit that drives the fold reinforcing roller, the method comprising:
folding the sheet bungle with the folding unit to form a fold;
conveying the sheet bundle having the fold formed thereon by the folding unit;
stopping the sheet bundle in a fold reinforcing position where the fold is reinforced by the fold reinforcing roller;
moving the fold reinforcing roller present in a standby position in a direction of the fold of the sheet bundle formed by the folding unit;
calculating a value of an electric current of the driving circuit flowing when the fold reinforcing roller rides over an end of the sheet bundle; and
determining, on the basis of the value of the electric current, a number of times the fold reinforcing roller is reciprocatingly moved along the fold of the sheet bundle formed by the folding unit and reinforcing the fold.

7. The method according to claim 6, further comprising:
reciprocatingly moving the fold reinforcing roller a first number of times if the value of the electric current is smaller than the threshold; and
reciprocatingly moving the fold reinforcing roller a second number of times larger than the first number of times if the value of the electric current exceeds the threshold.

8. The method according to claim 7, wherein
the threshold is plural threshold to which different numbers of times of fold reinforcement are set, and
the method further comprises selecting, on the basis of the value of the electric current, a relevant threshold out of the plural thresholds and reciprocatingly moving the fold reinforcing roller a number of times of fold reinforcement set to the relevant threshold.

9. The method according to claim 8, further comprising setting a number of times of fold reinforcement to the threshold via an operation section.

10. A sheet processing apparatus comprising:
folding means for folding a sheet bundle including plural sheets to form a fold;
fold reinforcing means for nipping the fold of the sheet bundle having the fold formed thereon and conveyed to a fold reinforcing position, reciprocatingly moving along a direction of the fold, and reinforcing the fold of the sheet bundle;
driving means for driving the fold reinforcing means along the direction of the fold; and
controlling means for controlling a number of times of the reciprocating movement of the fold reinforcing means on the basis of a value of an electric current of the driving means flowing when the fold reinforcing means that starts driving from a standby position rides over an end of the sheet bundle.

11. The apparatus according to claim 10, wherein, if the value of the electric current is smaller than a threshold, the controlling means reciprocatingly moves the fold reinforcing means a first number of times and, if the value of the electric current exceeds the threshold, the controlling means reciprocatingly moves the fold reinforcing means a second number of times larger than the first number of times.

12. The apparatus according to claim 11, wherein
the threshold is plural thresholds to which different numbers of times of fold reinforcement are set, and
the controlling means determines a relevant threshold out of the plural threshold on the basis of the value of the electric current and reciprocatingly moves the fold reinforcing means a number of times of fold reinforcement set to the relevant threshold.

13. The apparatus according to claim 12, further comprising operation means for setting a number of times of fold reinforcement to the threshold.

14. The apparatus according to claim 11, wherein the controlling means calculates a value of an electric current flowing through the driving means.
